(19) United States
(12) Patent Application Publication
(10) Pub. No.: US 2026/0278880 A1
(43) Pub. Date: Sep. 17, 2026

(54) SYSTEM

(71) Applicant: SoftBank Group Corp., Tokyo (JP)

(72) Inventor: Toshiki MATSUMURA, Tokyo (JP)

(73) Assignee: SoftBank Group Corp., Tokyo (JP)

(21) Appl. No.: 19/551,600

(22) Filed: Feb. 27, 2026

Related U.S. Application Data
(60) Provisional application No. 63/770,729, filed on Mar. 12, 2025.

(51) Int. Cl. G06T 11/60; G06F 40/20; G06T 17/00; G06V 10/40; G06V 40/16

(52) U.S. Cl. CPC G06T 11/60; G06F 40/20; G06T 17/00; G06V 10/40; G06V 40/175

(57) ABSTRACT

A system includes a processor that is configured to obtain a face image of a user, receive a natural language input regarding a desired hairstyle of the user, analyze the face image to extract facial features of the user, analyze the natural language input to extract hairstyle features, generate a three-dimensional hairstyle model suitable for the user based on the facial features and the hairstyle features, superimpose the generated three-dimensional hairstyle model on the face image of the user and display the superimposed result, present a plurality of hairstyle options to the user based on the displayed three-dimensional hairstyle model, and share a hairstyle option selected by the user with a hairstylist.

### CROSS-REFERENCE TO RELATED APPLICATION

This application claims the benefit of U.S. Provisional Application No. 63/770,729, filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for selecting and communicating hairstyles between users and hairstylists rely heavily on static images, vague verbal explanations, or non-personalized catalogs. As a result, users often experience a mismatch between an imagined hairstyle and the actual haircut, leading to dissatisfaction and repeated corrections at the salon. Existing systems generally do not integrate detailed facial analysis with a user's natural language description of a desired hairstyle, nor do they generate realistic three-dimensional hairstyle models that are tailored to the user's specific facial features. Furthermore, conventional approaches provide limited support for presenting multiple suitable hairstyle options to the user and for accurately sharing the user's final choice with a hairstylist in a form that preserves the intended style details. There is therefore a need for a system that can: (i) precisely analyze a user's face image, (ii) interpret a user's natural language input regarding a desired hairstyle, (iii) generate a realistic three-dimensional hairstyle model suitable for the individual user, (iv) present multiple hairstyle options in an intuitive manner, and (v) reliably share a selected hairstyle option with a hairstylist to improve the quality and predictability of hairdressing services.

### SUMMARY

In order to solve the above-described problems, the invention provides a system comprising a processor configured to functionally integrate image analysis, natural language processing, three-dimensional model generation, recommendation, and sharing. The processor is configured to obtain a face image of a user and receive a natural language input regarding a desired hairstyle of the user. The processor is further configured to analyze the face image to extract facial features of the user, including detailed information such as a contour of the face and positions of eyes, a nose, a mouth, and a jaw, and to classify a shape of the face of the user, for example into at least one of a round shape, an oval shape, and a square shape, thereby collecting basic data for evaluating suitability of hairstyles. The processor is also configured to analyze the natural language input to extract hairstyle features by extracting keywords, understanding a context of the input, and identifying hairstyle attributes such as length, style, and bangs based on the extracted keywords and context. Based on the extracted facial features and hairstyle features, the processor is configured to generate a three-dimensional hairstyle model suitable for the user, to customize the three-dimensional hairstyle model according to the user's facial shape and characteristics, and to apply shading and texturing to provide realistic hair volume and texture. The processor is further configured to superimpose the generated three-dimensional hairstyle model on the face image of the user and display the superimposed result, to present a plurality of hairstyle options to the user on the basis of the displayed three-dimensional hairstyle models, and to share a hairstyle option selected by the user with a hairstylist. By these means, the system enables users to visually confirm and compare hairstyle options that are tailored to their own facial features, and allows hairstylists to receive a detailed, realistic representation of the selected hairstyle, thereby improving communication and enhancing user satisfaction with the resulting haircut.

The term “system” refers to a combination of one or more hardware devices and software components that collectively perform the functions recited in the claims, including image acquisition, natural language input processing, image analysis, three-dimensional model generation, display, recommendation, and sharing.

The term “processor” refers to one or more hardware processing units, such as a central processing unit (CPU), graphics processing unit (GPU), digital signal processor (DSP), or other computing circuitry, which executes instructions and performs the operations specified in the claims.

The term “face image” refers to digital image data including at least a portion of a user's face, such that facial features including a face contour and positions of eyes, a nose, a mouth, and a jaw can be analyzed and extracted.

The term “natural language input” refers to text or speech data expressed in a human language, such as English or Japanese, which describes a desired hairstyle and is suitable for linguistic analysis to extract hairstyle-related information.

The term “desired hairstyle” refers to a target hairstyle that a user wishes to obtain, including one or more attributes such as hair length, hair shape or style, presence or absence of bangs, bangs type, hair color, and hair volume.

The term “facial features” refers to structural and positional characteristics extracted from a face image, including but not limited to a face contour, positions of eyes, a nose, a mouth, and a jaw, as well as derived parameters such as face width, face height, and jawline shape.

The term “hairstyle features” refers to attributes of a hairstyle extracted from the natural language input, including but not limited to hair length, hairstyle type, bangs type, hair texture, hair color preference, and any constraints or conditions specified by the user.

The term “three-dimensional hairstyle model” refers to digital three-dimensional data representing a hairstyle, including geometric information such as a mesh or volumetric representation, and optionally appearance information such as color, shading, and texture, which is configured to be visually rendered and superimposed on a user's face image.

The term “superimpose” refers to the operation of positioning and rendering at least a portion of a three-dimensional hairstyle model over a face image, such that the hairstyle appears aligned with the user's facial features when displayed.

The term “display” refers to the presentation of visual information, including a face image, a three-dimensional hairstyle model, or a superimposed result thereof, on a screen or other visual output device for viewing by a user.

The term “hairstyle options” refers to two or more alternative three-dimensional hairstyle models or variations thereof, each representing a different hairstyle configuration or styling variation that can be selected by the user.

The term “high resolution” refers to an image quality or pixel density sufficient to allow accurate identification of fine facial details, including a face contour and positions of eyes, a nose, a mouth, and a jaw, for the purposes of analysis as described in the claims.

The term “face shape” refers to a classification of an overall geometric form of a user's face, determined from facial features and proportions, and including categories such as round shape, oval shape, and square shape, among others.

The term “basic data for evaluating suitability of hairstyles” refers to analytical data derived from the face image, including face shape classification and positional information of facial features, which is used to determine how well different hairstyles may match or complement the user's face.

The term “keywords” refers to one or more salient words or phrases extracted from the natural language input, which carry significant meaning related to hairstyle attributes, such as “shoulder-length,” “bob,” or “side-swept bangs.”

The term “context” refers to linguistic relations, meanings, or dependencies among words, phrases, and sentences in the natural language input, which are used to interpret the user's intent and to accurately derive hairstyle features.

The term “shading” refers to a rendering process in which lighting and shadow effects are calculated and applied to a three-dimensional hairstyle model so as to provide a realistic perception of hair volume, depth, and shape.

The term “texturing” refers to the application of surface properties, patterns, or color maps to a three-dimensional hairstyle model to represent hair appearance characteristics such as color, glossiness, and fine structural detail.

The term “hairstylist” refers to a professional or service provider who performs haircutting, hair styling, or related hair treatment services, and who receives a selected hairstyle option from the system for reference during such services.

The term “share” refers to transmitting or making available information about a selected hairstyle option, including at least an identifier or representation of a three-dimensional hairstyle model and optionally related descriptive data, from the system associated with the user to a system or device accessible by a hairstylist.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

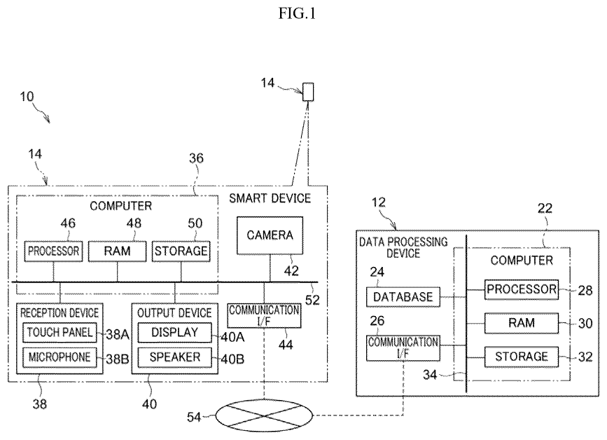

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

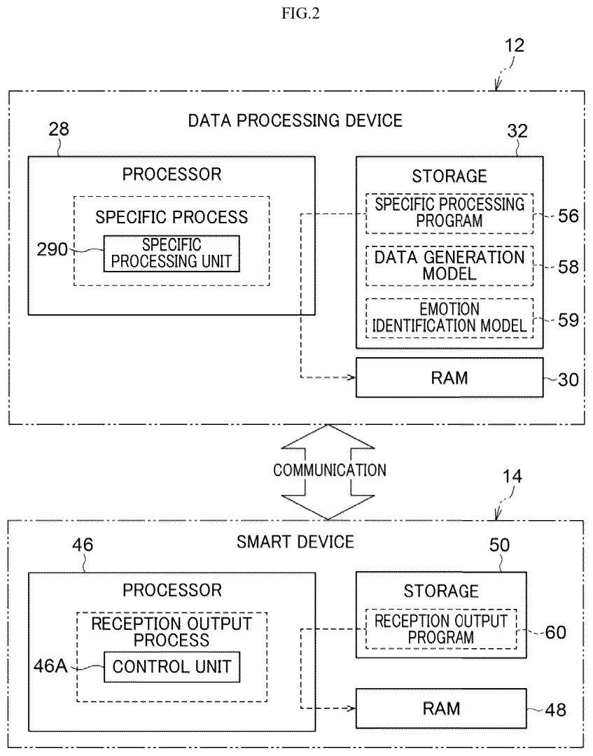

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented style simulation systems that overlay a candidate appearance style on a user image typically rely on manually predefined style templates and simple parameter sliders. Such systems generally do not robustly interpret free-form natural language descriptions from users, and they do not tightly integrate image-based geometric analysis with language-derived semantic attributes. As a result, the systems often produce recommended styles that are poorly aligned with the actual facial geometry of the user, and require substantial manual tuning, thereby increasing processing time and reducing usability.

Moreover, conventional systems that attempt to incorporate machine learning often treat generative models, image analysis models, and recommendation logic as independent components, without a coherent data flow that connects (i) low-level image features such as contour and landmark information, (ii) high-level style attributes derived from natural language, and (iii) user and practitioner feedback after real-world application of the style. This fragmented architecture leads to inefficient use of computational resources, duplication of processing, and difficulty in systematically improving model performance over time based on historical outcomes.

In addition, existing generative AI models, when used in isolation, are not typically constrained by the actual user geometry or by structured, normalized attributes extracted from natural language input. Generative results can be visually appealing but geometrically inconsistent with the user's head shape, hairline, or other physical constraints, thereby limiting the reliability of the generated three-dimensional style models as practical guides for practitioners.

Furthermore, known systems generally provide static recommendation outputs and do not implement a closed-loop learning mechanism that uses both user satisfaction data and practitioner feedback to refine subsequent analysis, generation, and recommendation processes. Consequently, such systems fail to improve recommendation accuracy and generation quality over time in a systematic, data-driven manner.

Accordingly, there is a need for a computer-implemented system and server-side processing architecture that: (i) jointly processes body-part images and natural language style descriptions, (ii) converts unstructured language input into constrained structured attribute information using generative AI models with explicit prompt sentences, (iii) generates three-dimensional style models that are geometrically consistent with analyzed user features, (iv) produces multiple parameterized style candidates programmatically rather than through ad hoc templates, and (v) continuously updates its analysis and recommendation behavior based on recorded history and feedback, thereby improving technical performance of the style generation and recommendation process itself.

The specific processing by the specific processing unit 290 of the data processing device 12 in Example 1 is realized by the following means.

The present invention provides a server comprising at least one processor and at least one memory storing instructions that, when executed by the at least one processor, cause the server to acquire a body-part image of a user and corresponding natural language input regarding a desired appearance style, to analyze the body-part image to extract shape feature data including contour information and feature point information, to analyze the natural language input to extract style feature data including length information, shape information, color information, and fringe information, to normalize the style feature data into structured attribute information by transmitting inquiry data including a prompt sentence to a generative AI model and receiving, as a response, structured attribute information, to generate a three-dimensional shape model of an appearance style suitable for the user based on the shape feature data and the structured attribute information, to perform virtual rendering by setting virtual illumination and viewpoint positions for the three-dimensional shape model and generating two-dimensional images from a plurality of directions, to superimpose at least one of the three-dimensional shape model and the two-dimensional images on the body-part image and generate a display screen for presentation to the user, to generate and present a plurality of appearance-style candidates by programmatically varying at least one of length information, color information, volume information, and fringe information using the structured attribute information as parameters, to transmit to a practitioner terminal device data including a three-dimensional shape model, two-dimensional images, and the structured attribute information corresponding to a selected appearance-style candidate, and to record history information including the selected appearance-style candidate and evaluation information from at least one of the user and the practitioner terminal device and perform learning control that updates at least one of the analysis processing of the style feature data and the presentation processing of the appearance-style candidates based on the history information. This enables a technically improved, end-to-end style generation and recommendation pipeline in which image analysis, natural language understanding, generative AI modeling, visualization, and feedback-driven learning are integrated into a unified server-side architecture that reduces manual intervention, improves geometric and semantic consistency of generated styles, enhances computational efficiency, and progressively increases the accuracy and relevance of recommended appearance styles.

The term “body-part image” refers to digital image data representing at least a portion of a human body, including but not limited to a face, captured by an image-capturing device and stored as electronic information.

The term “natural language input” refers to character-based or speech-recognition-based textual information expressed in a human language and provided by a user to describe a desired appearance style.

The term “appearance style” refers to a set of visual attributes relating to the outward look of a body part, including at least hair-related attributes such as length, shape, color, fringe configuration, and volume, and optionally including additional styling attributes.

The term “shape feature data” refers to numerical or symbolic data derived from a body-part image that represents geometric properties of the body part, including at least contour information and feature point information such as landmark positions.

The term “contour information” refers to data indicating an outline of a body part or region in an image, including boundary coordinates or equivalent representation of the shape of the body part.

The term “feature point information” refers to data indicating positions of specific points of interest on a body part, such as eye positions, nose position, mouth position, or jawline points, expressed as coordinates or related descriptors.

The term “style feature data” refers to data extracted from natural language input that represents semantic attributes of a desired appearance style, including at least length information, shape information, color information, and fringe information.

The term “length information” refers to data indicating a desired or generated extent or size of a style dimension, such as hair length relative to anatomical reference points.

The term “shape information” refers to data indicating the overall form or configuration of an appearance style, such as straight, wavy, layered, bob, or similar geometric characterizations.

The term “color information” refers to data indicating a chromatic property of an appearance style, such as a color name, code, or numerical color parameters.

The term “fringe information” refers to data indicating characteristics of a frontal hair region or equivalent element, including presence, direction, length, or arrangement of a fringe or bangs.

The term “volume information” refers to data indicating a perceived or modeled fullness, thickness, or three-dimensional extent of an appearance style, particularly for hair-related styles.

The term “structured attribute information” refers to data in a predetermined, machine-readable format, such as a key-value structure or schema-based object, that encodes style attributes derived from natural language input and optionally refined by a generative AI model.

The term “generative AI model” refers to a machine-learned computational model configured to generate output data, such as structured attributes or three-dimensional models, in response to input data, including prompt sentences and conditioning information.

The term “prompt sentence” refers to textual data formulated as an instruction or query to a generative AI model, specifying a task or desired output format and including at least part of the natural language input or related context.

The term “inquiry data” refers to data transmitted to a generative AI model, including at least one prompt sentence and optionally additional conditioning information, to request generation of output data.

The term “three-dimensional shape model” refers to electronic data representing a three-dimensional geometric object, including vertex, edge, and surface information or an equivalent representation, which models an appearance style on a body part.

The term “virtual illumination” refers to rendering parameters and data defining one or more simulated light sources used to compute shading and appearance of a three-dimensional shape model in a virtual environment.

The term “viewpoint position” refers to rendering parameters and data defining the position and orientation of a virtual camera relative to a three-dimensional shape model for generating two-dimensional images.

The term “two-dimensional image” refers to raster or vector image data with two spatial dimensions generated by rendering a three-dimensional shape model from a given viewpoint under specified virtual illumination.

The term “display screen” refers to visual output data or a graphical user interface frame that is generated for presentation on a display device and that may include overlays of a body-part image, three-dimensional models, and two-dimensional images.

The term “appearance-style candidate” refers to one instance of an appearance style configuration generated by the system, characterized by a specific combination of style attributes, and presented to a user as a selectable option.

The term “treatment-terminal device” refers to an electronic device operated by a practitioner, such as a stylist or technician, that receives shared information including models, images, and attributes, and is used to review or apply an appearance style in a real-world procedure.

The term “shared information” refers to data transmitted from the server to a treatment-terminal device, including at least one three-dimensional shape model, at least one two-dimensional image, and associated structured attribute information for a selected appearance-style candidate.

The term “history information” refers to stored data representing past interactions, including selected appearance-style candidates, evaluation information from users or practitioners, and any related contextual data used for learning control.

The term “evaluation information” refers to data indicating a qualitative or quantitative assessment of an appearance-style candidate or an applied style, provided by a user or practitioner, such as ratings, comments, or modification records.

The term “learning control” refers to a process in which one or more machine-learning models or algorithm parameters are updated based on history information, so as to improve at least one of analysis processing of style feature data and presentation processing of appearance-style candidates.

The term “analysis processing of the style feature data” refers to computational operations that interpret natural language input or structured attribute information to identify and refine style-related attributes for use in model generation or recommendation.

The term “presentation processing of the appearance-style candidates” refers to computational operations that generate, select, arrange, or modify appearance-style candidates for display to a user based on structured attribute information and history information.

In one embodiment, a server cooperates with one or more terminals to implement the claimed system. The server comprises at least one processor, at least one memory, a network interface, and an acceleration unit such as a graphics processing unit. The terminal comprises at least one processor, at least one memory, a camera module, a microphone, a display device, and a touch-input interface. The server and the terminal execute software modules that perform image acquisition, natural language processing, feature extraction, generative model execution, rendering, recommendation, data logging, and learning control.

The terminal captures a body-part image, such as a facial image, by controlling a camera module via an operating system camera application programming interface. For example, the terminal uses a camera framework that provides access to image sensor parameters, focus control, exposure control, and resolution settings. The terminal displays alignment guides, such as a rectangular frame and a center line, using a user-interface framework. The terminal thereby supports consistent image capture conditions, which directly improve the quality of feature extraction performed later on the server.

The terminal accepts natural language input regarding a desired appearance style. The terminal provides a text input field implemented by the user-interface framework and, optionally, a voice input control. When the user selects voice input, the terminal records audio through the microphone and sends the audio to a speech recognition engine. The terminal receives recognized text from the speech recognition engine and displays it in the text input field. The terminal stores the final natural language input in memory and transmits the input together with the captured image to the server using a network library over a secure communication protocol.

The server receives image data and natural language text through the network interface and stores the raw data in a data store such as a relational database and an object storage. The server decodes the image data into a multi-dimensional numerical array using an image processing library. The server converts pixel values from device-specific color spaces into a normalized color space and resizes the image to a predetermined resolution suitable for neural network input.

The server analyzes the body-part image with a convolutional neural network configured for face detection and landmark regression. The server may employ a multi-stage convolutional neural network in which early layers perform low-level edge and texture detection and later layers perform high-level pattern recognition to locate facial features. The server outputs feature point information such as coordinates of eyes, a nose tip, corners of a mouth, and multiple jawline points. The server then computes contour information by interpolating the jawline points and other boundary landmarks. The server calculates numeric features such as face width, face height, cheekbone width, and jaw width, and forms a feature vector.

The server classifies a face-shape type using a machine learning classifier such as a gradient boosted decision tree or a fully connected neural network that receives the feature vector as input. The classifier outputs a symbolic label such as “round”, “oval”, or “square”, and a confidence score. The server stores the shape feature data, including contour information, feature point information, and face-shape type, in a structured data record that can be indexed and retrieved efficiently.

The server analyzes the natural language input using a natural language processing pipeline.

The server first performs tokenization and part-of-speech tagging with a statistical or neural sequence model. The server then extracts candidate phrases for length, shape, color, and fringe attributes using rule-based pattern matching and domain-specific dictionaries. The server constructs preliminary style feature data that may contain ambiguous or underspecified values.

The server normalizes the style feature data into structured attribute information by contacting a generative AI model. The server uses a generative AI model that is implemented as a transformer-based neural network with multiple attention layers trained on a corpus of style-related descriptions and corresponding structured outputs. The server transmits inquiry data that includes a prompt sentence and the raw user text. The prompt sentence is formulated to instruct the generative AI model to return style attributes in a constrained form, which reduces downstream parsing complexity and errors.

For example, the server sends a prompt sentence such as:

“You are a hairstyle expert. From the following user description, extract structured attributes: hair length, base style, bangs style, curl type, and color. Respond in plain text listing each attribute and its value. Description: ‘I want a shoulder-length bob with side-swept bangs and dark brown color.”

In another example, the server sends a prompt sentence such as:

“Interpret the following hairstyle request and normalize it to the closest standard attributes for length, style shape, fringe configuration, and color tone. Use concise English words for each attribute. Request: ‘Medium bob that touches my shoulders, side fringe, natural brown.” The server receives the generative AI model output as text and parses the output to extract structured attribute information, such as length=“shoulder”, style=“bob”, fringe=“side-swept”, curl=“straight”, and color=“dark brown”. The server resolves conflicts between the rule-based extraction and the generative AI output by applying deterministic prioritization rules and consistency checks. This combination of deterministic rules and generative AI with explicit prompt sentences improves accuracy and robustness compared to conventional single-method parsing.

The server generates a three-dimensional shape model of an appearance style suitable for the user. The server maintains a library of base head meshes and hair templates. The server selects a base head mesh and applies a morphing procedure to align the base mesh with the user-specific face geometry derived from the feature point information. The morphing procedure adjusts vertex positions of the head mesh by solving an optimization problem that minimizes a distance between projected landmark positions on the mesh and detected landmarks in the image, thereby achieving geometric consistency.

The server determines hair parameters from the structured attribute information. For example, the server maps “shoulder” length to a numerical length parameter measured in a normalized head height unit, maps “bob” style to a predefined curve profile for hair strands, and maps “dark brown” color to an RGB or equivalent color code. The server initializes a hair generation module that may employ a generative adversarial network or a diffusion-based neural network trained to output hair meshes or volumetric hair fields conditioned on such parameters.

The server executes the generative AI model for hair in a conditioned manner. The server encodes the face-shape type, hairline contour, and length parameter into a latent vector and feeds this vector into the generative model. The generative model produces a three-dimensional hair representation in the coordinate system of the morphed head mesh. The server post-processes the generated hair geometry by enforcing topological constraints, removing self-intersections, and smoothing strands to meet rendering requirements.

The server assigns a physically-based material to the hair geometry. The server defines parameters such as specular reflection coefficient, roughness, index of refraction, and anisotropy to simulate realistic hair appearance. The server also defines texture maps that control color variation, highlight intensity, and strand-level noise. The server uses a three-dimensional rendering engine to create two-dimensional images from multiple virtual camera positions under defined virtual illumination conditions.

The server overlays at least one of the rendered two-dimensional images or a simplified three-dimensional model onto the original body-part image. The server performs geometric alignment by projecting the three-dimensional model onto the image plane using the camera pose estimated from facial landmarks. The server composites the rendered hair image with the original image using alpha blending, depth-aware masking, or other blending techniques to preserve occlusion relationships. This blended image is sent to the terminal and displayed, so that the user perceives a realistic simulation of the appearance style.

The server generates a plurality of appearance-style candidates by programmatically varying style parameters. The server modifies numeric parameters such as hair length, volume, or fringe angle within allowed ranges that depend on the face-shape type and hairline position.

The server also modifies color parameters by shifting hue or brightness to nearby tones. The server uses structured attribute information as a base vector and applies deterministic perturbations to generate candidate vectors, which are then passed through a fast hair model generation stage that may reuse intermediate geometry to save computation.

The server optionally consults the generative AI model to propose attribute variations. In one example, the server sends a prompt sentence such as:

“Given an oval face and a base hairstyle defined as shoulder-length bob with side-swept bangs and dark brown color, propose three subtle variations that change only length, volume around the cheeks, or fringe angle. Describe each variant using concise attribute words.”

The server parses the response and generates additional candidates that follow those attribute changes. The server scores these candidates using a recommendation model that receives feature vectors describing style attributes, face-shape compatibility measures, and historical preference weights. The recommendation model may be implemented as a gradient boosted tree or a neural network trained to predict a satisfaction score. The server selects top-ranked candidates and sends them to the terminal.

The terminal displays the plurality of appearance-style candidates using a graphical user interface. The terminal may display thumbnail images in a carousel and allow the user to select any candidate for detailed viewing. When the user selects a candidate, the terminal may request or load a three-dimensional model and enable interactive rotation or zooming using the device graphics processor. The terminal applies efficient rendering techniques such as level-of-detail control and cached textures to reduce computational load and latency.

The server transmits to a practitioner terminal device the three-dimensional shape model, two-dimensional images, and structured attribute information corresponding to a user-selected appearance-style candidate. The practitioner terminal device displays the shared information and may include additional tools such as measurement overlays or section-view visualization to support practical application. The practitioner thereby receives a precise, machine-generated geometric and attribute definition that is directly based on user-specific analysis, rather than a generic reference image.

The server records history information that ties together the user, the selected appearance-style candidate, evaluation information, and any modifications reported by the practitioner.

The server stores this history in a structured form suitable for machine learning, including input features, selected attributes, outcome ratings, and correction data. The server periodically executes learning control processes to update one or more models. For example, the server retrains the face-shape classifier using new labeled examples, fine-tunes the generative AI model with prompt-response pairs that led to high satisfaction, or recalibrates the recommendation model using updated preference signals.

The server improves computational performance by organizing data and models into modular components and by reducing redundant computations. For instance, the server caches intermediate features such as face-shape type and landmark positions, and reuses them across multiple candidate generations. The server also uses batched processing and hardware acceleration to process multiple requests in parallel. These implementations reduce overall processing time and server load, demonstrating a technical improvement over naive or manual approaches.

The server achieves technical accuracy improvements by combining deterministic rules, structured attribute normalization via generative AI with prompt sentences, and feedback-driven learning. By constraining generative AI outputs through explicit prompts and structured parsing, the server reduces ambiguity and error in attribute extraction. By conditioning hair generation on precise geometric feature data, the server enforces alignment between generated models and real-world geometry, thereby reducing mismatch and error in visual simulations.

The server improves data management by using well-defined data structures for shape feature data, style feature data, structured attribute information, three-dimensional model descriptors, and history records. This facilitates efficient indexing, retrieval, and incremental updating of models. The server reduces communication load by sending compact representations, such as model identifiers and parameter sets, when possible, instead of repeatedly transmitting full geometry for minor variations.

The system employs AI and computer processing in a way that goes beyond mere automation of human tasks. The neural networks and generative models operate on high-dimensional feature vectors that humans cannot directly process and exploit correlations learned from large datasets to produce geometry-consistent, parameterized, and machine-usable outputs.

The use of explicit prompt sentences to constrain and normalize model behavior is a non-conventional practice relative to simple keyword matching, and it directly enhances the internal data structures and subsequent computational steps.

In alternative embodiments, the server may use different model architectures. For example, the server may use a transformer-based encoder-decoder for image analysis, a graph neural network for mesh morphing, or a variational autoencoder for hairstyle parameterization. The generative AI model for attribute normalization may be hosted locally or accessed via an external service. The face-shape classification may be replaced or supplemented by clustering methods that group users into shape categories without explicit labels.

In another embodiment, the terminal may perform part of the image analysis locally using a lightweight neural network optimized for mobile processors, and transmit only extracted feature data to the server, thereby reducing network bandwidth usage. In yet another embodiment, the practitioner terminal device may provide additional feedback, such as actual cut lengths or applied color formulas, which the server uses as labeled training data for further model improvement.

Through these embodiments and variations, the server, the terminal, and the user cooperate in a technically specific workflow that integrates image acquisition hardware, neural-network-based analysis and generation, structured attribute normalization by generative AI with prompt sentences, high-fidelity three-dimensional rendering, and feedback-driven learning control. This integrated architecture yields measurable improvements in accuracy, speed, and resource usage compared to conventional systems that rely on manual template selection, simplistic image overlays, or isolated, non-coordinated machine learning components.

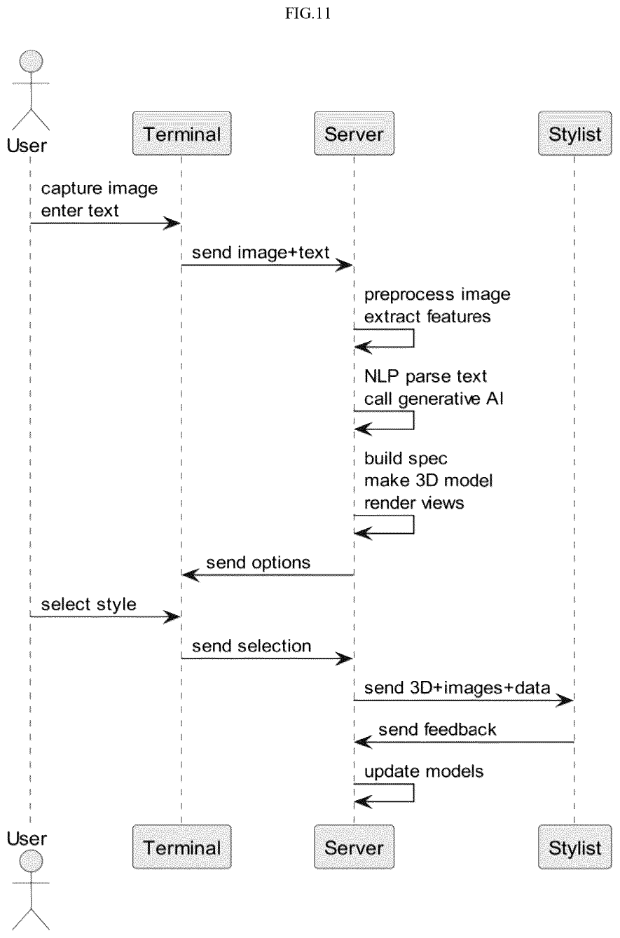

The following describes the processing flow using FIG. 11.

### Step 1:

The terminal acquires a body-part image from a camera module.

The terminal receives as input raw sensor data from the image sensor via an operating system camera API, and the terminal outputs compressed image data (for example, a JPEG file) and associated metadata such as resolution, exposure time, and timestamp.

The terminal controls focus, exposure, and white balance settings through the camera API based on preview frames, displays an on-screen guide frame to assist the user in positioning the face or other body part, and captures the frame when the user activates a capture control (for example, taps a shutter button).

The terminal stores the captured image data in a local buffer and prepares it for transmission.

### Step 2:

The terminal acquires natural language input describing a desired appearance style.

The terminal receives as input user interaction with a text input field or microphone control, and the terminal outputs a finalized text string representing the natural language description.

The terminal, when the user types text, collects each keystroke event and concatenates characters into a string buffer; when the user uses voice input, the terminal records audio signals from the microphone, sends the audio to a speech-recognition component, receives a recognized text hypothesis, and displays it for user confirmation.

The terminal allows the user to edit or correct the text, and, when the user confirms the description, the terminal stores the text in memory as the natural language input.

### Step 3:

The terminal transmits the captured image and the natural language input to the server.

The terminal receives as input the compressed image data and the natural language text string stored in local memory, and the terminal outputs a network request message including both data items and a user or session identifier.

The terminal constructs a structured request payload, for example a multipart or JSON body, attaches authentication information, and sends the payload to the server using a secure communication protocol such as HTTPS.

The terminal then awaits a response and logs transmission success or failure.

### Step 4:

The server receives and stores the transmitted data.

The server receives as input the network request message containing the compressed image data, natural language text, and identifiers, and the server outputs stored records in a data store, including a raw image file and a database record referencing the image and text.

The server parses the request, validates formats and sizes, decodes headers, and, if validation succeeds, writes the image data to object storage and the text and metadata to a database table, generating an internal request ID.

The server associates the request ID with the user identifier and timestamps for later retrieval.

### Step 5:

The server performs image preprocessing on the body-part image.

The server receives as input the stored compressed image file referenced by the request ID, and the server outputs a normalized image tensor suitable for neural network input.

The server loads the image into an image processing library, decodes it to pixel arrays, rescales it to a predetermined resolution, converts it to a normalized color space (for example, RGB with values scaled to [0,1]), and optionally applies cropping around the expected face region.

The server then arranges the pixel data into a multi-dimensional numerical array and stores it in memory for subsequent analysis.

### Step 6:

The server extracts shape feature data from the normalized image.

The server receives as input the normalized image tensor, and the server outputs shape feature data including contour information, feature point information, and derived geometric measurements.

The server applies a convolutional neural network configured for landmark detection to the image tensor, computes coordinates of key points such as eyes, nose, mouth, and jawline, and aggregates these coordinates into a feature point list.

The server interpolates along the jawline and other boundary landmarks to produce contour information, calculates distances and ratios such as face width and height, and packs these measurements into a feature vector representing the shape feature data.

### Step 7:

The server classifies a face-shape type based on the shape feature data.

The server receives as input the feature vector containing geometric measurements extracted from the feature point information, and the server outputs a symbolic label representing a face-shape type and an associated confidence score.

The server feeds the feature vector into a classifier model such as a gradient-boosted decision tree or a fully connected neural network, executes the model on a processor or accelerator, and obtains prediction scores for multiple shape categories.

The server selects the category with the highest probability as the face-shape label, attaches the confidence score, and adds this information to the shape feature data.

### Step 8:

The server performs initial natural language processing on the appearance-style description.

The server receives as input the natural language text string stored under the request ID, and the server outputs preliminary style feature data including candidate phrases for length, shape, color, and fringe attributes.

The server tokenizes the text into words, assigns part-of-speech tags using a language model, and identifies noun phrases and adjective phrases.

The server compares these phrases against a domain-specific dictionary of style terms and uses rule-based patterns to extract attribute candidates, such as identifying “shoulder-length” as a length term and “bob” as a shape term, and stores these as preliminary style feature data.

### Step 9:

The server normalizes the style feature data using a generative AI model with a prompt sentence.

The server receives as input the preliminary style feature data and the original natural language text, and the server outputs structured attribute information in a predetermined attribute set.

The server constructs inquiry data that includes a prompt sentence and the original text, for example:

“You are a hairstyle expert. From the following user description, extract structured attributes: hair length, base style, bangs style, curl type, and color. Respond in plain text listing each attribute and its value. Description: ‘I want a shoulder-length bob with side-swept bangs and dark brown color.’”

The server sends this inquiry data to the generative AI model, receives a textual response describing normalized attribute values, and parses the response to extract attribute-value pairs.

The server merges these pairs with the preliminary style feature data, resolves conflicts according to predetermined priority rules, and stores the result as structured attribute information, such as standardized length, style, fringe configuration, curl type, and color.

### Step 10:

The server integrates shape feature data and structured attribute information into a design specification.

The server receives as input the shape feature data, including face-shape label and landmark positions, and the structured attribute information, and the server outputs a combined design specification object.

The server creates a data structure that contains fields for geometric properties, such as face width, height, and shape type, and fields for style attributes, such as desired length, base style, fringe style, and color.

The server may encode numeric values directly and convert categorical attributes to numeric codes or embeddings, and then stores the combined design specification for downstream three-dimensional model generation.

### Step 11:

The server morphs a base head mesh according to the shape feature data.

The server receives as input a selected base three-dimensional head mesh from a mesh library and the shape feature data including landmark positions and geometric measurements, and the server outputs a morphed head mesh adapted to the user's geometry.

The server associates landmarks on the base mesh with target positions derived from image landmarks, computes displacement vectors for mesh control points, and optimizes vertex positions to minimize differences between projected mesh landmarks and target positions while preserving mesh smoothness.

The server stores the resulting morphed head mesh as the geometric foundation for hair model attachment.

### Step 12:

The server generates a three-dimensional hair geometry conditioned on the design specification.

The server receives as input the morphed head mesh and the design specification object containing structured attribute information, and the server outputs a three-dimensional hair geometry in the coordinate system of the morphed head.

The server encodes relevant attributes, such as length, style, and color, into a conditional input vector and feeds this vector, along with geometric features of the head, into a generative neural model configured for hair generation.

The server executes the generative model to produce hair geometry data, such as positions of hair strands or a hair surface mesh, applies post-processing to remove artifacts, and attaches the hair geometry to the morphed head mesh.

Step 13: The server assigns rendering parameters and generates two-dimensional views.

The server receives as input the combined head-and-hair three-dimensional model and the structured attribute information, and the server outputs rendered two-dimensional images from multiple virtual viewpoints.

The server sets virtual illumination parameters, including direction, intensity, and color of light sources, and sets virtual camera positions for front, three-quarter, and side views.

The server applies physically based shading models to compute color and brightness per surface element, executes the rendering engine to convert the three-dimensional model into two-dimensional raster images, and stores these images for subsequent overlay and display.

### Step 14:

The server superimposes the generated appearance style on the original body-part image.

The server receives as input at least one rendered two-dimensional hair image and the original body-part image with corresponding landmark positions, and the server outputs a composite image that visually overlays the generated style on the user's body part.

The server computes a projection mapping between the three-dimensional model and the image plane using camera pose estimates derived from landmarks, scales and aligns the rendered hair image with the original face image, and applies blending algorithms that respect occlusion and transparency.

The server generates a final composite image and stores it for transmission to the terminal.

### Step 15:

The server generates multiple appearance-style candidates by varying style attributes.

The server receives as input the design specification object for a base style and the shape feature data, and the server outputs a set of variant design specification objects corresponding to multiple appearance-style candidates.

The server programmatically perturbs attribute values, for example by increasing or decreasing length parameters within face-proportion-dependent limits, adjusting volume-related parameters near cheeks or crown, or changing fringe angles, and may also shift color parameters by small steps.

The server optionally sends a prompt sentence to the generative AI model to obtain suggested variations and combines deterministic perturbations with AI-suggested changes, creating a structured set of candidate specifications.

### Step 16:

The server produces models or images for the appearance-style candidates and sends them to the terminal.

The server receives as input the set of variant design specifications and the morphed head mesh, and the server outputs a collection of candidate preview images and associated identifiers.

The server either reuses parts of the base geometry and modifies only affected parameters, or regenerates lighter-weight hair models for each candidate, renders preview images for each candidate using previously defined rendering settings, and associates each image with an internal candidate ID.

The server packages the candidate IDs, descriptive texts derived from attribute values, and preview image references into a response message and transmits this response to the terminal.

### Step 17:

The terminal displays candidate appearance styles and accepts user selection.

The terminal receives as input the response message containing candidate IDs, descriptions, and preview images or their locations, and the terminal outputs a selected candidate ID and optional user comments.

The terminal decodes the response, loads preview images into a graphical interface, and presents them in a list or carousel view, allowing the user to scroll and inspect each candidate.

The terminal detects when the user selects a candidate and, if supported, loads a corresponding three-dimensional model for interactive viewing, and then records the selected candidate ID and any free-text feedback entered by the user.

### Step 18:

The terminal transmits the selected candidate information to the server.

The terminal receives as input the selected candidate ID and any user comments, and the terminal outputs a selection message to the server that includes the user identifier and candidate information.

The terminal constructs a request payload with the selection data and transmits it over the network using a secure protocol, then waits for an acknowledgment.

The terminal may store a local record of the selection for future reference.

### Step 19:

The server prepares and transmits shared information to a practitioner terminal device.

The server receives as input the selection message containing the selected candidate ID and user identifier, and the server outputs a share package sent to a practitioner terminal device.

The server retrieves the three-dimensional model, rendered images, and structured attribute information associated with the selected candidate, formats these into a share package, and may generate a concise text description of the style using predefined templates or additional generative processing with a prompt sentence.

The server transmits the share package to the practitioner terminal device, ensuring that the practitioner can access the geometric and attribute details needed for real-world implementation.

### Step 20:

The server records history information and executes learning control.

The server receives as input the selected candidate information, any evaluation information from the user or practitioner, and the original analysis data, and the server outputs updated model parameters or updated internal configuration for analysis and recommendation.

The server writes a history record linking the user, the style attributes, the generated models, and the evaluation outcomes into a structured database, then uses this dataset to retrain or fine-tune internal models such as the face-shape classifier or recommendation model.

The server adjusts model weights by computing loss functions on training batches, performing gradient-based updates, and deploying updated models to improve future prediction accuracy and candidate ranking.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional virtual try-on systems and avatar rendering systems typically treat avatar generation, garment simulation, and recommendation as separate subsystems connected only by static identifiers. In many cases, an avatar is generated once using a fixed pipeline, garments are then draped on the avatar using precomputed meshes or simplified collision handling, and recommendations are produced by generic ranking engines that are not aware of the detailed simulation results or the user's individual visual feedback. As a consequence, the overall system often suffers from several technical limitations.

First, existing systems generally lack an integrated mechanism for using high-resolution user appearance data, extracted facial and body features, and usage context to dynamically construct rich prompt sentences for a generative AI model. Without such a mechanism, the generative AI model cannot reliably produce three-dimensional body models and decoration models that are structurally constrained for real-time physics-based garment simulation. This often results in inconsistent mesh topology, incompatible skeleton structures, or ill-posed textures, which cause failures or instabilities in downstream rendering and simulation modules.

Second, typical pipelines do not tightly couple generative AI outputs with physics-based simulation in a closed loop controlled by the server. Because the avatar model, clothing models, and simulation parameters are not co-designed or co-generated, the simulation engine must frequently fall back to conservative approximations, such as rigid overlays or pre-authored animations, leading to unrealistic deformation behavior of garments and accessories. These approximations degrade the quality of the virtual try-on state and increase the computational cost required to correct interpenetrations and visual artifacts at runtime.

Third, many recommendation engines operate purely on abstract item identifiers, purchase logs, and coarse user segments. They do not systematically exploit the rich data produced by the virtual try-on process itself, such as per-garment deformation states, appearance under different illumination conditions, or user reactions to specific simulated outfits. As a result, recommendation quality is constrained by sparse and noisy signals, and cannot be easily personalized at the level of individual visual appearances of garments on a particular three-dimensional body model.

Fourth, there is insufficient infrastructure in conventional systems for using generative AI both at the avatar/garment generation stage and at the recommendation stage via specialized prompt sentences that encode technical constraints and user-specific conditions. Existing uses of generative AI are often limited to cosmetic image generation or static content suggestions, without leveraging model outputs to directly improve the consistency and efficiency of a graphics and simulation pipeline on a server. This leads to redundant computation, fragmented data flows, and suboptimal resource utilization in a networked computer environment.

Accordingly, there is a need for a system and a server-side processing architecture that: (i) acquires and analyzes high-resolution user appearance information to extract normalized feature information; (ii) automatically composes structured prompt sentences that encode generation instructions, constraints, and expression conditions for a generative AI model; (iii) uses the generative AI model to generate three-dimensional body models and decoration models that are natively compatible with physics-based simulation; (iv) performs integrated simulation and rendering of virtual try-on states under varying illumination conditions; and (v) continuously refines recommendation policies and prompt templates using detailed usage and reaction information. By addressing these issues, the system can improve the operation of computer graphics pipelines, simulation engines, and recommendation modules in a coordinated and technically efficient manner.

The specific processing by the specific processing unit 290 of the data processing device 12 in Application Example 1 is realized by the following means.

The present invention provides a server comprising a processor and a storage device, the processor being configured to acquire image information including appearance information of a user from a user device, to analyze the image information to extract feature information including facial part information, contour information, and expression information, to normalize the feature information and generate generation input data based on the normalized feature information, to generate, based on the generation input data and usage situation information related to the user, a natural language prompt sentence describing generation instructions, constraint conditions, and expression conditions for generating a three-dimensional body model corresponding to the user and a decoration target model applicable to the three-dimensional body model, to input the prompt sentence and the generation input data into a generative AI model and receive, from the generative AI model, model data including the three-dimensional body model and the decoration target model, to store the model data in the storage device while managing parameters of the three-dimensional body model including body shape information, build information, and external appearance attribute information, to obtain digital shape data representing clothing item information and accessory information and calculate an attachment state of the clothing item information and the accessory information with respect to the three-dimensional body model based on the parameters, to simulate, by a physical computation process, deformation behavior of the clothing item information and the accessory information according to the attachment state and generate a virtual try-on state of the clothing item information and the accessory information on the three-dimensional body model under one or more illumination condition information, to render the virtual try-on state from a plurality of viewpoints and generate display image data, to analyze selection history information, purchase history information, evaluation information, and reaction information related to the virtual try-on state as usage situation information, to calculate, based on a result of the analysis, a plurality of combinations of clothing item information and accessory information suitable for the user, and to generate, for at least one of the plurality of combinations, a recommendation prompt sentence for input to the generative AI model so as to cause the generative AI model to automatically generate or update a corresponding virtual try-on state in a personalized manner. This enables an integrated computer-implemented pipeline in which avatar generation, physics-based garment simulation, rendering, and recommendation are coordinated through structured prompt sentences for a generative AI model, thereby improving consistency of three-dimensional model topology, stability of simulation, personalization of recommendations, and overall computational efficiency of the server in providing virtual try-on services.

The term “image information” refers to digital data representing a visual capture of at least a part of a user, including but not limited to a face, head, or body, obtained by an image sensing device such as a camera and stored in a computer-readable format.

The term “appearance information” refers to information included in the image information that represents visual characteristics of a user, including at least one of facial features, skin tone, hair characteristics, and body outline.

The term “feature information” refers to data derived from the image information by analysis, including but not limited to facial part information, contour information, expression information, and numerical descriptors of such information.

The term “facial part information” refers to information indicating positions, shapes, or relative relationships of facial components, including at least eyes, nose, mouth, jaw, and cheek regions.

The term “contour information” refers to information indicating boundary shapes or outlines of at least a face or body part of the user, represented in a coordinate system suitable for further processing.

The term “expression information” refers to information indicating a facial expression state of the user, including but not limited to neutral, smiling, frowning, or other categorized expression types derived from the image information.

The term “generation input data” refers to data prepared as input for a generative AI model, the data including normalized feature information and optionally additional attributes such as body parameters, context information, or preference information.

The term “usage situation information” refers to information related to how a user interacts with the system over time, including at least selection history information, purchase history information, evaluation information, reaction information, and contextual information such as season or event type.

The term “prompt sentence” refers to a sequence of natural language tokens that encodes generation instructions, constraint conditions, expression conditions, or recommendation conditions for input to a generative AI model.

The term “recommendation prompt sentence” refers to a prompt sentence specifically constructed to cause a generative AI model to propose or generate one or more recommended combinations of items, virtual try-on states, or styles suitable for a user.

The term “generative AI model” refers to a machine learning model configured to generate new data, including at least three-dimensional model data or style data, based on input data and a prompt sentence, the model being implemented by one or more trained neural networks.

The term “model data” refers to data output by the generative AI model, including at least a three-dimensional body model, a decoration target model, and associated parameters or metadata.

The term “three-dimensional body model” refers to a digital representation of a human or humanoid body, including at least a geometric mesh, surface information, and optionally skeleton information, that can be used for simulation and rendering.

The term “decoration target model” refers to a digital representation of an item intended to be worn or attached to the three-dimensional body model, including at least clothing item models and accessory models.

The term “body shape information” refers to parameter values describing overall proportions or measurements of the three-dimensional body model, including at least height, width, girth, and relative limb lengths.

The term “build information” refers to information indicating a physique type of the three-dimensional body model, including but not limited to slim, standard, or heavy build classifications represented by numerical parameters.

The term “external appearance attribute information” refers to parameters representing outward appearance attributes of the three-dimensional body model, including at least skin tone, hair color, and general style attributes.

The term “digital shape data” refers to data defining a geometry of a three-dimensional object, including but not limited to mesh vertices, edges, faces, and associated topology information.

The term “clothing item information” refers to information representing a wearable object for the three-dimensional body model, including at least type, size, material properties, and associated digital shape data.

The term “accessory information” refers to information representing an additional decorative or functional object applicable to the three-dimensional body model, including at least jewelry, bags, or footwear and associated digital shape data.

The term “attachment state” refers to information indicating a relative positional and configurational relationship between clothing item information or accessory information and the three-dimensional body model, including at least alignment, fitting, and contact regions.

The term “physical computation process” refers to a simulation process executed by a computer to determine deformation or motion of objects according to physical laws, including at least mass-spring methods, finite element methods, or rigid body dynamics.

The term “deformation behavior” refers to temporal changes in shape or configuration of clothing item information or accessory information when influenced by forces, collisions, or movement of the three-dimensional body model.

The term “virtual try-on state” refers to a state in which the three-dimensional body model is represented as wearing or carrying particular clothing item information and accessory information, after simulation and positioning have been performed.

The term “illumination condition information” refers to information defining lighting conditions under which a virtual scene containing the three-dimensional body model is rendered, including at least light source positions, intensities, and colors.

The term “display image data” refers to digital image data generated by rendering the virtual try-on state from one or more viewpoints, suitable for display on an output device.

The term “selection history information” refers to data representing items or combinations that the user has selected, viewed, or tried on in the past within the system.

The term “purchase history information” refers to data representing items or combinations that the user has purchased through the system.

The term “evaluation information” refers to explicit or implicit feedback provided by the user with respect to items, combinations, or virtual try-on states, including at least ratings, likes, or preference indications.

The term “reaction information” refers to information indicative of user responses or external user responses to virtual try-on states, including at least click behavior, sharing behavior, or interaction with shared content.

The term “recommendation policy information” refers to parameters or rules used by the system to determine which combinations of clothing item information and accessory information should be recommended to a user.

The term “personalized virtual try-on states” refers to virtual try-on states that are generated or selected based on feature information, usage situation information, and preference information specific to an individual user.

The term “user device” refers to any computing device operated by a user, including at least a smartphone, tablet, personal computer, or head-mounted display.

The term “storage device” refers to any tangible computer-readable medium configured to store data, including but not limited to semiconductor memory, magnetic storage, and optical storage.

The term “transaction processing apparatus” refers to a computing system configured to process commercial transactions, including at least payment authorization, order registration, and related record management.

The term “sharing information” refers to data used to allow external users to view or access a virtual try-on state, including at least image data, identifiers, or network resource locators.

The term “external user” refers to an entity different from the primary user, capable of receiving shared information and optionally providing reactions or feedback.

In one embodiment, a server, a terminal, and a user cooperatively implement the system according to the above claims. The server includes at least one processor and a storage device. The processor executes program modules for image acquisition management, feature extraction, prompt sentence construction, generative AI model interaction, three-dimensional model management, physical simulation, rendering, and recommendation control. The terminal includes a processor, a memory, a display, and an image sensing device such as an integrated camera.

The terminal acquires image information including appearance information of the user by using an imaging software module executed on the terminal. The terminal uses an operating system level camera framework (for example, a generic camera API corresponding to mobile operating systems such as a mobile camera framework or a media capture API) to control hardware parameters such as exposure time, sensor gain, focus distance, and frame resolution.

The terminal superimposes guideline graphics on a preview image using a graphics user interface library and a graphics processing unit (GPU) in order to assist the user in placing the face in a desired pose and position. The terminal thereby acquires image information with a resolution equal to or higher than a predetermined resolution and transmits the image information to the server through a network interface using a secure protocol.

The server receives the image information via a network communication module implemented, for example, using an HTTP server framework. The server stores the raw image information in the storage device using a file system or an object storage system. The server then performs feature extraction on the stored image information by using a computer vision library such as a general-purpose image processing library and a landmark detection model.

The server converts each image into an internal data structure such as a multi-dimensional array (tensor) with shape (height, width, channel). The server applies image normalization operations including color space conversion, pixel value scaling, and geometric transformation (rotation, scaling, and cropping) so that the face region is aligned to a canonical coordinate system.

The server analyzes the normalized tensor by applying a convolutional neural network (CNN) trained for facial landmark detection. In one example, the CNN has multiple convolutional layers with rectified linear unit (ReLU) activations, pooling layers, and fully connected layers that output two-dimensional coordinates of a predetermined set of facial points (for example, eyes, nose tip, mouth corners, chin points). The server interprets the CNN output as facial part information and contour information. The server further uses an additional classifier network or a softmax output layer to categorize an expression state (for example, neutral, smile, frown) and stores this as expression information. The server aggregates these results into a feature vector representing feature information. The feature vector is stored in the storage device as generation input data associated with a user identifier.

The server performs normalization of the feature information by subtracting mean values and dividing by standard deviations that were previously computed on a training dataset, or by applying a feature scaling method such as min-max normalization. This step stabilizes the numerical range of inputs for subsequent neural network processing, which improves convergence and reduces numerical errors in the generative AI model.

The server constructs a prompt sentence by combining template text with the normalized feature information and usage situation information. The server uses a prompt generation module that accesses a template repository stored in the storage device. Each template includes literal text sections and placeholder tokens indicating positions where technical constraints and user-specific attributes should be inserted. The server fills the placeholders with information such as body shape classification, preferred colors, target usage context (for example, business, casual, formal), and required output type (for example, full-body three-dimensional model with rig, specific garment categories). The server generates, for example, the following prompt sentences:

“Generate a realistic three-dimensional full-body avatar based on the attached frontal face image. Preserve the user's facial features (face shape, eyes, nose, mouth) and create a neutral facial expression. Output a rigged model suitable for virtual clothing try-on and physics-based simulation.”

“Analyze the user's past virtual try-on and purchase history and generate three recommended outfits for a formal business meeting, each including a jacket, a top, and trousers. Prioritize neutral colors and slim silhouettes.”

By structuring prompt sentences in this way, the server ensures that the generative AI model receives explicit constraints about model topology, rigging requirements, and compatibility with downstream physics simulation. This results in three-dimensional model outputs that are more consistent and technically usable than naive unconstrained image generation.

The server implements the generative AI model as a neural network system stored in the storage device and executed on one or more processing units, which may include a graphics processing unit (GPU) or a tensor processing unit. In one embodiment, the generative AI model includes an encoder-decoder architecture with a latent representation. A first encoder network (for example, a CNN-based encoder) receives the normalized face image tensor and outputs a latent vector representing facial attributes and identity. A second encoder network receives auxiliary inputs such as body parameters and style attributes. A decoder network, implemented as a generative adversarial network (GAN), a variational autoencoder (VAE), or a diffusion-based model, synthesizes three-dimensional geometry (for example, vertex positions in a mesh), texture maps (for example, albedo, normal, roughness), and rigging parameters.

The server trains the generative AI model prior to deployment by using a training dataset of pairs of facial images and corresponding three-dimensional body models with known rigging and clothing compatibility. The server uses a loss function that combines multiple components, including reconstruction loss (for example, L1 or L2 distance between generated and ground-truth vertex positions), perceptual loss (using feature distances in intermediate layers of a reference CNN), adversarial loss (from a discriminator network), and topology consistency loss (penalizing invalid or self-intersecting meshes). The server updates the model parameters by gradient descent using an optimizer such as stochastic gradient descent, Adam, or its variants. The server performs data augmentation on the training dataset, such as random rotations, scaling of images, color jitter, and small perturbations of body measurements, to improve the robustness of the model.

During inference, the server supplies the generation input data and the prompt sentence to the generative AI model. For diffusion-type architectures, the prompt sentence is converted into an embedding vector by a natural language encoder such as a transformer network, and this embedding conditions the generative process. For GAN-type architectures, the prompt sentence is encoded and concatenated to the latent vector as conditional information. The server thereby obtains model data that includes a three-dimensional body model with a consistent skeleton structure and one or more decoration target models such as base garments or accessories.

The server stores the model data in an asset management structure, for example in a relational database with tables for users, base avatars, clothing assets, and accessory assets. Each entry includes pointers to mesh data files, texture files, skeleton descriptions, and simulation parameters. The server also stores parameters such as body shape information (for example, encoded as principal component coefficients of a statistical body model), build information (for example, a categorical or numeric code), and external appearance attribute information (for example, skin tone index, default hair color).

The server then obtains digital shape data representing clothing item information and accessory information from a product repository. Each clothing item is represented as a mesh with material attributes. The server maps the clothing mesh to the skeleton of the three-dimensional body model by computing skinning weights or cloth attachment points. The server computes an attachment state that defines the initial positioning of the clothing relative to the body mesh, as well as anchor points for simulation.

The server performs a physical computation process using a cloth simulation module. In one embodiment, the server uses a mass-spring model, where each vertex of the clothing mesh is treated as a mass node, and edges between vertices are treated as springs with predetermined stiffness and damping coefficients. The server computes forces on each node from gravity, body movement, and collisions with the body mesh. The server integrates equations of motion using a numerical integrator such as explicit Euler, semi-implicit Euler, or Verlet integration. The server uses collision detection between the clothing mesh and the body mesh, and between different layers of clothing, by using a broad-phase and narrow-phase collision algorithm. The broad-phase algorithm may rely on bounding volume hierarchies, and the narrow-phase algorithm may use distance computations between triangles. The server thereby simulates deformation behavior of the clothing item information and accessory information as they interact with the three-dimensional body model.

The server applies illumination condition information in a rendering module. The rendering module uses a physically based rendering (PBR) pipeline, in which each material has parameters such as base color, metallic factor, roughness, and normal map. The server defines light sources (for example, directional lights, point lights, spotlights) and environment maps (for example, high dynamic range images). The server renders display image data from multiple viewpoints by computing shading using the PBR model and the simulated garment geometry. The server encodes the resulting images as compressed image files or as frame buffers for streaming.

The server analyzes usage situation information by aggregating selection history information, purchase history information, evaluation information, and reaction information. The server stores this information in a structured format, for example as user-event logs, where each log entry includes a user identifier, item identifier, event type (select, view, try-on, purchase, share), timestamp, and optional score (for example, rating, like). The server computes statistics such as frequency of selection, conversion rate, and dwell time per item and per category. The server inputs these statistics into a recommendation engine implemented as a neural network-based collaborative filtering model or a gradient-boosted decision tree model.

The server utilizes a separate language model or a hybrid model as part of the recommendation engine. The server constructs a recommendation prompt sentence using templates and aggregated user information. For example, the server generates:

“Based on the following user history:
Prefers neutral colors (black, gray, navy) and simple, minimalist designs.
Frequently tries on jackets and slim-fit pants.
Purchased two formal blazers in the past three months.
Recommend five complete outfits (top, bottom, and optional outerwear) suitable for a business-casual office environment. Output product categories, preferred colors, and style descriptions.”

The server encodes this prompt sentence using a text encoder model and combines it with vector representations of items and users. The recommendation engine outputs a ranked list of clothing item combinations. The server filters out items that are incompatible with the three-dimensional body model or current inventory and then generates new prompt sentences for generating or updating corresponding virtual try-on states. The server thereby calls the generative AI model again with recommendation prompt sentences that explicitly describe which garments and accessories should be combined and under what conditions they should be simulated and rendered.

By using structured prompt sentences as explicit control signals for the generative AI model and by feeding back simulation results and reaction information into recommendation policy updates, the server improves the technical performance of the system. Specifically, the server reduces failures in garment draping by generating three-dimensional body models and garment models that share compatible skeleton and topology definitions. This reduces the number of corrective computations needed in the physics engine and accelerates simulation convergence. The server also reduces communication load by generating only those virtual try-on states that are predicted to be relevant to the user, based on internal recommendation scores and learned policies, rather than enumerating all possible combinations.

The server improves accuracy of personalization by leveraging high-dimensional feature information and latent representations learned from training data, which cannot be reasonably reproduced by manual human rules. The server performs automatic adaptation of prompt sentence templates and recommendation policies by using machine learning techniques on interaction logs, which leads to a measurable reduction in the mismatch between recommended outfits and user selections. For example, the server can compare recommendation outcomes with subsequent purchases and adjust weighting of features in the recommendation model, thereby lowering the error in predicting user choices.

The server implements the internal neural network architectures, feature extractions, and training procedures in a way that is not a mere automation of human visual judgment or stylistic recommendation. Unlike human stylists who rely on qualitative reasoning, the server uses explicit numeric feature vectors, gradient-based optimization, and large-scale data aggregation. The server constructs non-intuitive combinations of internal features (for example, joint embeddings of facial structure, garment deformation patterns, and illumination responses) that are optimized to satisfy both physical constraints and user preference predictions. This non-conventional integration of generative modeling, physics simulation, and language-based conditioning constitutes a specific improvement to the functioning of the computer system, including accelerated convergence in simulation, reduced rendering errors, and improved caching and reuse of three-dimensional assets.

In another embodiment, the server uses a diffusion-based generative AI model in which the decoder is implemented as a denoising network that iteratively refines a noisy latent representation into a clean representation of a three-dimensional body model and decoration models. The server controls the diffusion process by adjusting a guidance scale parameter derived from the prompt sentence embedding, thereby trading off fidelity to the prompt against diversity of outputs. The server may also implement a variational autoencoder-GAN hybrid, where the encoder-decoder structure ensures continuity in the latent space for smooth interpolation between body shapes, and the adversarial discriminator ensures realism of outputs.

In another embodiment, the server partitions the generative AI model into multiple submodels: a face-to-head model, a head-to-body model, and a body-to-garment compatibility model. The server composes prompt sentences that indicate, for each submodel, explicit constraints and target outputs. This modular architecture allows the server to update specific components (for example, garment compatibility) without retraining the entire system, thereby improving maintainability and extensibility.

In yet another embodiment, the terminal executes part of the rendering processing locally by downloading simplified three-dimensional assets and material data from the server. The terminal then runs a lightweight rendering engine using a graphics library to display interactive views while the server performs heavy physics simulation and generative modeling. In that case, the server transmits reduced representation data (for example, low-polygon meshes and compressed textures) to minimize bandwidth, and the terminal upscales or interpolates animations. This division of labor between the server and the terminal reduces network load and improves responsiveness perceived by the user.

The user interacts with the system by viewing display image data on the terminal, changing viewpoint or zoom level, selecting recommended outfits, and initiating purchases. However, the critical computations for generating the three-dimensional body model, simulating garment deformation, and constructing recommendation prompt sentences are executed on the server in a way that optimizes hardware utilization (for example, GPU batch processing, parallel simulation of multiple garments, caching of frequently used models).

Through these embodiments, the system realizes a concrete technical solution in which the server, the terminal, and the user collaborate via specific data structures, neural network architectures, and prompt sentence constructions. The system improves processing speed, accuracy of three-dimensional avatar generation, stability and realism of garment simulation, and efficiency of recommendation, thereby constituting an improvement to computer technology rather than a mere automation of human mental processes or business practices.

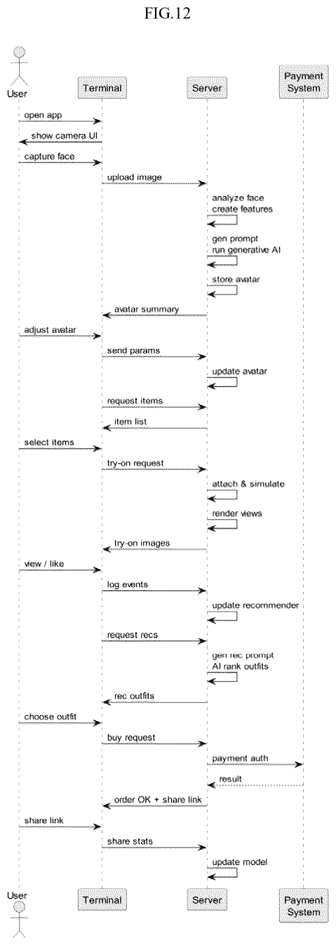

The following describes the processing flow using FIG. 12.

### Step 1:

The terminal initializes an application and prepares an image capture interface.

The terminal loads a camera control module, a user interface module, and a network communication module into memory. The terminal configures the integrated camera with default parameters (resolution, frame rate, exposure) and allocates a frame buffer to store preview images.

Input: no external input, internal configuration data.

Output: initialized camera session, GUI elements (preview window, capture button, guideline overlay).

### Step 2:

The user positions a face in front of the terminal and triggers image capture.

The user holds the terminal such that the face appears within a guideline displayed on the screen and maintains a frontal pose. The user optionally taps a capture button, or the terminal automatically captures when conditions are met.

Input: visual scene including the user's face.

Output: raw sensor data received by the terminal's camera pipeline.

### Step 3:

The terminal acquires face image information and performs local validation.

The terminal converts raw sensor data into an image frame (for example, a YUV or RGB bitmap), applies basic denoising and auto-exposure correction, and then runs a lightweight face detection algorithm. The terminal detects at least one face region and checks whether the face is frontal and centered based on bounding box location and aspect ratio.

Input: raw image frame from the camera sensor.

Output: validated face image, face bounding box coordinates, validation status (pass/fail).

### Step 4:

The terminal encodes and transmits the image information to the server.

The terminal crops the image around the face bounding box, resizes the cropped region to a target resolution, and encodes the result as a compressed image (for example, JPEG). The terminal constructs a request payload including the compressed image, device identifier, and user identifier, and sends the payload to the server over a secure network connection.

Input: validated face image and associated metadata.

Output: network request message containing compressed image information.

### Step 5:

The server receives and stores the image information.

The server accepts the network request, parses header and body, and extracts the compressed image. The server writes the compressed image to a storage device and creates a database record linking the stored image file to a user identifier and a timestamp.

Input: network request message from the terminal.

Output: stored image file reference and database record containing image metadata.

### Step 6:

The server decodes the image and generates normalized feature information.

The server decodes the compressed image into a tensor representation (for example, height×width×3 color channels). The server runs a facial landmark detection model to obtain coordinates of facial parts (eyes, nose, mouth, jawline). The server computes contour information by tracing the outer boundary of the detected landmarks and estimates expression information by classifying facial muscle patterns using a trained classifier network. The server assembles facial part information, contour information, and expression information into a feature vector, then normalizes each component (for example, zero-mean, unit-variance).

Input: decoded face image tensor from storage.

Output: normalized feature vector representing feature information.

### Step 7:

The server creates generation input data for the generative AI model.

The server transforms the normalized feature vector into a generation input data structure including coordinates, classification labels, and additional user attributes such as height, general build category, or style preference flags if available. The server formats this data as a numeric array or structured object compatible with the generative AI model's input layer.

Input: normalized feature vector and stored user attributes.

Output: structured generation input data ready for model inference.

### Step 8:

The server composes a prompt sentence for avatar generation.

The server accesses a template repository and selects a template corresponding to avatar creation. The server fills placeholders in the template with user-specific parameters such as target realism level, required rigging type, and use case (virtual try-on). For example, the server generates the prompt sentence:

“Generate a realistic three-dimensional full-body avatar based on the attached frontal face image. Preserve the user's facial features (face shape, eyes, nose, mouth) and create a neutral facial expression. Output a rigged model suitable for virtual clothing try-on and physics-based simulation.”

Input: template text and user-specific parameters from the database.

Output: fully instantiated prompt sentence for generative AI model conditioning.

### Step 9:

The server executes the generative AI model to create model data.

The server passes the generation input data and the prompt sentence into the generative AI model. The server encodes the prompt sentence with a text encoder, generating a prompt embedding vector, and feeds the generation input data into the model's encoder network. The server concatenates or otherwise fuses the prompt embedding and the encoded visual features into a latent representation. The server then runs a decoder network that outputs three-dimensional body mesh vertices, skeleton data, and decoration target mesh data (for example, base garments or generic clothing shells).

Input: generation input data and prompt sentence.

Output: model data including a three-dimensional body model and one or more decoration target models.

### Step 10:

The server validates and stores the generated model data.

The server checks topology of the generated body mesh, verifying that there are no disconnected components, inverted normals, or self-intersections beyond a defined tolerance.

The server verifies that skeleton bones match a predefined rig specification (for example, count and hierarchy). If validation passes, the server stores mesh files, skeleton definitions, and associated parameters in the storage device and updates a user-to-avatar mapping in the database.

Input: model data from the generative AI model.

Output: persistent asset references and updated database records for the user's avatar.

### Step 11:

The server sends avatar summary information to the terminal.

The server extracts a low-resolution representation or parameter summary (for example, body shape coefficients, texture preview) from the stored avatar asset. The server constructs a response message containing the avatar identifier, thumbnail images, and adjustable parameter ranges (for example, body type scale, skin tone range).

Input: stored avatar asset and database records.

Output: network response to the terminal containing avatar summary and configuration options.

### Step 12:

The terminal displays the avatar preview and collects customization input.

The terminal receives the avatar summary information, loads a lightweight three-dimensional model or pre-rendered images, and displays a rotatable avatar preview. The user manipulates controls such as sliders and option lists to adjust parameters (for example, “body type: slim-standard-heavy,” “skin tone: light-medium-dark,” “hair length: short-medium-long”).

Input: avatar summary from the server and user interactions on the interface.

Output: updated customization parameters representing the user's avatar preferences.

### Step 13:

The terminal transmits customization parameters to the server.

The terminal packages the selected parameters (for example, body_type=slim, height=170, hair_style=short, hair_color=brown) into a structured request and sends it to the server as an update message.

Input: current customization parameters entered by the user.

Output: network message containing avatar customization instructions.

### Step 14:

The server updates the avatar model according to customization parameters.

The server loads the base avatar model, reads the customization parameters, and adjusts morph targets or body shape coefficients to generate a new body mesh. The server updates external appearance attributes (for example, skin tone, hair color) in the avatar's material parameters. The server may recompute textures or swap mesh variants for different hairstyles.

Input: base avatar asset and customization parameters from the terminal.

Output: updated three-dimensional body model and attribute set stored in the asset database.

### Step 15:

The terminal requests available clothing and accessory items.

The terminal sends a catalogue request to the server, specifying optional filters (for example, category=jackets, size range, price range). The user can refine the search by interacting with category filters on the interface.

Input: user-selected filters and catalogue request parameters.

Output: network request to retrieve item metadata and digital shape data references.

### Step 16:

The server supplies clothing item information and accessory information.

The server queries a product database to retrieve clothing item information and accessory information, including identifiers, categories, sizes, material attributes, and references to digital shape data. The server packages a list of items and associated summary images, then returns the list to the terminal.

Input: catalogue request and product database contents.

Output: list of clothing items and accessories with metadata and asset references.

### Step 17:

The user selects one or more items to try on.

The user browses the catalogue on the terminal and taps on a desired item (for example, “slim-fit jacket, size M”) to initiate virtual try-on. The user may add multiple items (for example, jacket, shirt, trousers) to be tried on simultaneously.

Input: displayed item list and user selection actions.

Output: selection identifiers of clothing items and accessories.

### Step 18:

The terminal sends a virtual try-on request to the server.

The terminal composes a request including the avatar identifier, one or more selected item identifiers, desired sizes, and current viewport preferences (for example, front, side, back). The terminal sends this request to the server to initiate simulation and rendering.

Input: avatar identifier and selected item identifiers from the user.

Output: network message initiating a virtual try-on session.

### Step 19:

The server calculates an attachment state between the avatar and the items.

The server loads the avatar body mesh and the clothing/accessory meshes from storage. The server scales or adjusts the clothing meshes according to selected size data. The server computes alignment transforms that map clothing anchor points (for example, waistline, shoulder seams) to corresponding body landmarks. The server constructs an attachment state describing relative positions, orientations, and attachment constraints between garment nodes and body nodes.

Input: avatar model, clothing/accessory models, and size parameters.

Output: attachment state data structure used as initial conditions for simulation.

### Step 20:

The server performs physical simulation to generate a virtual try-on state.

The server runs a cloth simulation solver that iteratively updates vertex positions of garment meshes under gravity, body constraints, and collision constraints. The server uses the attachment state as the starting configuration and advances the simulation through multiple time steps until a stable draped state is reached. The server computes deformation behavior and stores the resulting vertex positions as part of a virtual try-on state object.

Input: attachment state, avatar mesh, and garment mesh with material properties.

Output: virtual try-on state including deformed garment meshes aligned with the avatar.

### Step 21:

The server renders the virtual try-on state from multiple viewpoints.

The server configures a rendering pipeline with light sources and camera positions (for example, front, left side, right side, back). The server loads the deformed meshes into a rendering engine, evaluates shading using physically based rendering, and produces display image data for each viewpoint.

Input: virtual try-on state and illumination condition information.

Output: one or more rendered images showing the avatar wearing the selected items.

### Step 22:

The server sends the rendered images or rendering descriptors to the terminal.

The server encodes the rendered images in a compressed format (for example, PNG or JPEG) or generates a simplified scene description. The server returns the resulting data to the terminal as a try-on response.

Input: display image data or scene data in memory.

Output: network response containing visual representation of the virtual try-on state.

### Step 23:

The terminal displays the virtual try-on result to the user.

The terminal decodes the images or loads the scene data and presents the avatar wearing the selected clothing and accessories on the display. The user can swipe or tap to switch between different viewpoints, and the terminal updates the displayed image accordingly.

Input: try-on response data from the server.

Output: on-screen visualization of the virtual try-on result for user inspection.

### Step 24:

The server records usage situation information related to the try-on session.

The server logs events such as which items were tried on, how long the user viewed each combination, and whether the user favorited or dismissed a look. The server writes these events as entries in a usage log with timestamps and associated user identifiers.

Input: event messages sent from the terminal during user interaction.

Output: usage situation records stored in a logging or analytics database.

### Step 25:

The server analyzes accumulated usage situation information to update recommendation data.

The server processes historical logs to compute statistics (for example, item popularity, conversion probabilities, co-occurrence of items). The server feeds these statistics and user-specific histories into a recommendation model, which updates internal parameters to better predict which combinations are likely to be accepted or purchased.

Input: usage logs and existing recommendation model parameters.

Output: updated recommendation scores, feature weights, and policy information.

### Step 26:

The server constructs recommendation prompt sentences based on updated data.

The server selects a recommendation template and fills it with information summarizing the user's preferences and current context. For example, the server generates:

“Analyze the user's past virtual try-on and purchase history and generate three recommended outfits for a formal business meeting, each including a jacket, a top, and trousers. Prioritize neutral colors and slim silhouettes.”

The server formats this as a recommendation prompt sentence to be provided to a generative AI model used for style synthesis or ranking.

Input: updated recommendation data and template text.

Output: recommendation prompt sentences tailored to the user.

### Step 27:

The server calls a generative AI model to generate or refine recommended combinations.

The server encodes the recommendation prompt sentences and passes them together with candidate item vectors into a language-conditioned recommendation network. The network outputs ranked sets of item combinations that best fit the described criteria.

Input: recommendation prompt sentences and candidate item representations.

Output: ordered list of recommended item combinations associated with predicted scores.

### Step 28:

The server prepares virtual try-on states for recommended combinations.

The server selects top-ranked combinations and reuses the physical simulation and rendering pipeline to precompute or quickly compute virtual try-on states. The server optionally tunes simulation parameters (for example, pose, lighting) to best showcase each recommended outfit.

Input: recommended item combinations and current avatar model.

Output: multiple virtual try-on states and associated display image data.

### Step 29:

The terminal presents recommended outfits and enables user selection.

The terminal receives recommended combinations with preview images and displays them as selectable cards. The user taps on a card to view the full virtual try-on state. The terminal then displays the corresponding images or requests higher-resolution renderings if necessary.

Input: recommended outfit data from the server.

Output: user-facing list of personalized recommendations and selected recommendation identifier.

### Step 30:

The server sends product information for a selected virtual try-on state to a transaction processing apparatus.

When the user indicates an intention to purchase, the terminal transmits a purchase initiation message including selected item identifiers and quantities. The server validates stock, prepares a transaction record, and forwards relevant item and price information to an external or internal transaction processing apparatus.

Input: purchase initiation message from the terminal.

Output: transaction request message containing product and user information.

### Step 31:

The server receives a transaction result and generates transaction and sharing information.

The server obtains a success or failure response from the transaction processing apparatus. If successful, the server records the order in an order database and constructs sharing information such as an image URL or preview link for the purchased outfit. The server returns confirmation and sharing information to the terminal.

Input: transaction result and internal order record.

Output: transaction confirmation data and sharing metadata.

### Step 32:

The user optionally shares the virtual try-on state with external users.

The user activates a share function on the terminal and selects a communication channel (for example, messaging, social media). The terminal uses the sharing metadata received from the server to generate a message that includes a preview image or link to the virtual try-on state.

Input: sharing metadata and user selection of sharing channel.

Output: shared content delivered to external users and associated reaction data sent back to the server.

### Step 33:

The server incorporates external reaction information into future recommendation processing.

The server logs external user reactions (for example, click-through, likes) associated with shared content. The server incorporates these reactions into the recommendation model's training data, adjusting weights or rules to give higher priority to styles that receive positive external feedback.

Input: reaction events from external users or external services.

Output: updated recommendation parameters and templates for future prompt sentences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional hairstyle recommendation and simulation systems typically rely on simple rule-based matching between a user's face shape and a catalog of predefined hairstyle templates. In many implementations, a computing device merely overlays two-dimensional or three-dimensional hairstyle images on a user's face image without deeply analyzing the user's facial geometry, without structurally interpreting the user's natural language preferences, and without accounting for the user's emotional state during interaction. As a result, the underlying computer system performs only shallow pattern matching and static rendering operations, which limits both the quality of the generated hairstyle models and the relevance of the recommendations from the user's perspective.

In particular, conventional systems do not tightly integrate: (i) pixel-level analysis of a user's face and hair region, (ii) linguistic analysis that converts free-form natural language input into a structured hairstyle profile, (iii) multi-modal emotion estimation based on facial expressions, text sentiment, and user interaction logs, and (iv) dynamic construction of a prompt sentence that conditions a generative artificial intelligence model. Without such integration, the processing pipeline in existing systems cannot adapt the behavior of a generative model to the user's psychological tolerance for change, cannot systematically control the degree of hairstyle variation, and cannot generate three-dimensional hairstyle models that are optimized for both physical suitability and emotional acceptability. Moreover, many existing systems execute generative processing in a generic or “one-size-fits-all” manner, where a generative model is invoked with fixed or manually-authored prompts, independent of the image analysis results and emotion signals. This leads to inefficient use of computing resources, because the generative model may generate a large number of hairstyle candidates that are objectively misaligned with the user's face shape or subjectively outside the user's acceptable change range. The computer then must render and manage many low-relevance models, resulting in unnecessary data movement, memory consumption, and processing cycles on both server-side and client-side devices.

In addition, conventional recommendation engines typically operate only on static attributes, such as face shape or length preference, and do not dynamically reweight recommendation criteria in response to an estimated emotion state. This prevents the computing system from algorithmically biasing its ranking toward conservative candidates for anxious users or toward more radical candidates for users who exhibit a challenging or excited state. Consequently, the ranking logic remains largely static and does not exploit the full informational content of interaction logs and emotion analysis, which again represents a missed opportunity to improve computational efficiency and user satisfaction.

Furthermore, traditional sharing mechanisms between users and beauty treatment providers generally transmit only selected images or templates, and do not include structured information about the generative process, the underlying hairstyle profile, or the user's emotion state. As a result, the server infrastructure is not configured to maintain and transmit a rich, machine-interpretable description of the generated three-dimensional hairstyle models. This limits downstream automation, such as automated generation of stylist guidance comments, and forces human operators to infer user intent and constraints manually, which is an inefficient use of human and computer resources.

Accordingly, there is a need for a computer-implemented system that improves the internal operation of the server-side processing pipeline by: performing fine-grained image analysis of the user's face and hair, transforming natural language inputs into a structured hairstyle profile including an image change degree, computing a multi-modal emotion state, constructing and supplying a prompt sentence tailored to these conditions to a generative artificial intelligence model, generating multiple three-dimensional hairstyle models that are both physically and emotionally adapted to the user, algorithmically ranking the models in accordance with the estimated emotion state, and automatically packaging the selected model and emotion-aware comments for use by a beauty treatment provider. Such a system would not merely automate a human workflow, but would reconfigure how the computer allocates computation, memory, and model inference to generate more relevant three-dimensional hairstyle data with fewer wasted operations, thereby improving the functioning of the computer itself in the context of hairstyle generation and recommendation.

The specific processing by the specific processing unit 290 of the data processing device 12 in Example 2 is realized by the following means.

The present invention provides a server comprising a processor and a memory storing instructions, wherein the processor is configured to execute an image acquisition process to receive, from a client device, an image including a head of a user, execute an image analysis process to detect a face region in the image and to calculate feature values of a face shape and a hair region of the user on a pixel basis, execute a natural language analysis process to receive and analyze a natural language input regarding a desired hairstyle of the user, to perform morphological analysis and semantic analysis on the natural language input, and to generate a structured hairstyle profile including a plurality of attributes comprising at least length, shape, presence or absence of bangs, color, impression tendency, and degree of image change, execute an emotion estimation process to estimate, on a basis of at least one of an expression image of the user, the natural language input, and an operation history of the user, an emotion state of the user including at least anxiety, satisfaction, excitement, confusion, and indifference, execute a prompt generation process to generate a prompt sentence for a generative artificial intelligence model on a basis of the feature values of the face shape and the hair region, the hairstyle profile, and the emotion state, execute a generative inference process to input the prompt sentence and face information of the user into the generative artificial intelligence model and to cause the generative artificial intelligence model to generate a plurality of three-dimensional hairstyle models adapted to a head shape of the user, execute a data conversion and rendering preparation process to convert each of the plurality of three-dimensional hairstyle models into a standardized three-dimensional data format and to prepare data for superimposing each three-dimensional hairstyle model on a face image or a three-dimensional head model of the user, execute a recommendation process to calculate, for each of the plurality of three-dimensional hairstyle models, an evaluation value on a basis of at least one of a degree of suitability to the face shape of the user, a degree of change from a current hairstyle of the user, and a degree of suitability to the emotion state, and to determine an order of presentation of the plurality of three-dimensional hairstyle models according to the evaluation value, and execute a sharing process to generate and transmit, to an information processing terminal used by a beauty treatment provider, information regarding a three-dimensional hairstyle model selected by the user and comment information based on the emotion state in association with the selected three-dimensional hairstyle model. This enables the server to internally coordinate image analysis, natural language analysis, emotion estimation, prompt sentence generation, and generative artificial intelligence model inference so that computation and memory resources are directed toward generating and ranking three-dimensional hairstyle models that are simultaneously adapted to physical facial attributes and to a dynamically estimated emotion state of the user, thereby improving the efficiency, specificity, and technical performance of the computer system in generating, evaluating, and sharing hairstyle models.

The term “image including a head of a user” refers to digital image data in which at least a portion of a head of a human subject, including a face region and at least part of a hair region, is captured with sufficient resolution for subsequent analysis by an image processing algorithm.

The term “natural language input regarding a desired hairstyle of the user” refers to text data expressed in a human language, or text data obtained by speech recognition from spoken utterances, that describes a user's preference, requirement, or constraint concerning a hairstyle, including at least one of length, shape, fringe, color, and impression.

The term “face region” refers to a sub-region of an image including at least a forehead, eyes, nose, mouth, cheeks, and jawline of a human subject, the sub-region being determined by a detection algorithm that locates facial features based on pixel-level analysis.

The term “feature values of a face shape” refers to numerical data derived from an analysis of the face region, including at least one of distances, angles, ratios, or other geometric descriptors representing a contour of the face and relative positions of facial landmarks, and optionally a categorical label indicating a type of face shape.

The term “hair region” refers to a sub-region of an image corresponding to hair of a human subject, the sub-region being identified by a segmentation or classification algorithm that distinguishes hair pixels from skin and background pixels.

The term “feature values of the hair region” refers to numerical or categorical data derived from the hair region, including at least one of color statistics, spatial distribution, length indication, volume indication, or other descriptors relevant to hairstyle characterization.

The term “morphological analysis” refers to a natural language processing procedure that segments a text into tokens such as words or morphemes and assigns linguistic information such as part-of-speech tags, inflection, and base forms to the tokens.

The term “semantic analysis” refers to a natural language processing procedure that interprets meanings and relations between tokens, phrases, or sentences, and maps them to structured representations such as attributes, categories, or semantic roles.

The term “hairstyle profile” refers to structured data representing a desired hairstyle of a user, the structured data including a plurality of attribute fields such as length, shape, presence or absence of bangs, bangs direction, color preference, impression tendency, and degree of image change.

The term “length” in the context of the hairstyle profile refers to an attribute indicating a relative or absolute hair length of a hairstyle, expressed as a categorical value (for example, short, medium, long) or as a numerical measure associated with a position on a head or body.

The term “shape” in the context of the hairstyle profile refers to an attribute representing an overall geometric configuration of hair, including at least a classification such as bob, straight, layered, curly, wavy, or similar forms.

The term “presence or absence of bangs” refers to an attribute that indicates whether a hairstyle includes a portion of hair covering or partially covering a forehead region of a user.

The term “bangs direction” refers to an attribute describing a principal orientation or flow of bangs, including categories such as straight down, side-swept, center-parted, or other directional patterns.

The term “color” in the context of the hairstyle profile refers to an attribute representing a desired hair color or range of colors, expressed as a categorical label (for example, black, brown, blonde) or as a numerical representation in a color space.

The term “impression tendency” refers to an attribute describing an intended aesthetic or psychological impression of a hairstyle, including at least values such as natural, mature, cool, cute, casual, or formal.

The term “degree of image change” refers to an attribute that quantifies a relative amount of change between a current hairstyle of a user and a desired hairstyle, expressed as a numerical level or a categorical indicator of how drastically the user wishes to alter their appearance.

The term “operation history of the user” refers to log data representing a sequence of user interactions with a user interface, including at least timestamps and identifiers for actions such as selecting hairstyle candidates, switching between candidates, duration of viewing, and confirming or canceling selections.

The term “emotion state of the user” refers to data indicating a psychological condition of the user with respect to a hairstyle selection process, including at least one of anxiety, satisfaction, excitement, confusion, and indifference, and optionally a numerical score for each condition.

The term “expression image of the user” refers to an image or sequence of images capturing a face of a user during interaction with a system, the images being used for analysis of facial expressions to infer an emotion state.

The term “generative artificial intelligence model” refers to a machine learning model configured to generate new data such as image data or three-dimensional shape data from input conditions, where the model has been trained using a large amount of data and parameter optimization, and is capable of performing inference to produce novel outputs conditioned on input prompts and auxiliary information.

The term “prompt sentence” refers to a structured natural language text or equivalent textual representation that specifies conditions, constraints, and desired characteristics for data to be generated by a generative artificial intelligence model, including at least information derived from face analysis, hairstyle profile, and emotion state of a user.

The term “face information of the user” refers to data describing a face of a user, including at least one of an image of the face, a set of facial landmark coordinates, or a three-dimensional representation of the head, used as conditioning input to a generative artificial intelligence model.

The term “three-dimensional hairstyle model” refers to digital data representing a three-dimensional shape and surface appearance of hair corresponding to a hairstyle, including at least a geometric representation such as a mesh and associated texture or material information.

The term “standardized three-dimensional data format” refers to a data format commonly used for representing three-dimensional models, which specifies structures for geometry, materials, and textures, and is readable by multiple rendering or processing systems.

The term “evaluation value” refers to a numerical score computed for a three-dimensional hairstyle model on the basis of at least one criterion such as suitability to a face shape of a user, degree of change from a current hairstyle, or suitability to an emotion state, and used to rank or select models.

The term “degree of suitability to the face shape” refers to a measure indicating how well a three-dimensional hairstyle model harmonizes with or complements the geometric and categorical characteristics of a user's face, based on features such as proportions, contours, and alignment.

The term “degree of change from a current hairstyle” refers to a measure indicating how different a candidate hairstyle is from a current hairstyle of a user, the measure being calculated from differences in attributes such as length, color, volume, or presence of bangs.

The term “degree of suitability to the emotion state” refers to a measure indicating how well a candidate hairstyle aligns with a user's estimated emotion state, including whether the candidate is conservative or radical to a degree matching the user's tolerance or desire for change.

The term “information processing terminal used by a beauty treatment provider” refers to a computing apparatus, such as a workstation, tablet, or smartphone, operated by a professional who performs hair treatment or styling, and configured to receive and display data related to hairstyle models and user information.

The term “comment information based on the emotion state” refers to text data generated in association with a selected three-dimensional hairstyle model, the text data describing guidance or considerations for a beauty treatment provider, and being formulated in view of a user's emotion state and hairstyle preferences.

In one embodiment, a system includes a server, at least one terminal, and a communication network connecting the server and the terminal. The server includes at least one processor, a main memory, a non-volatile storage device, at least one graphics processing unit, and a network interface. The terminal includes a processor, a memory, a display, at least one imaging device, at least one input device including a touch panel and a microphone, and a wireless communication module. The server executes a server-side program on a general-purpose operating system, and the terminal executes a client-side application on a mobile operating system.

The terminal acquires a head image of a user by controlling the imaging device through a camera framework of the mobile operating system. For example, the terminal uses an image capture application programming interface to obtain a live preview stream and overlays a face-position guide frame on the preview using a user interface framework. When the user performs a capture operation, the terminal resizes the captured frame to a predetermined resolution using an image-processing library, encodes the resized image into a compressed format such as a JPEG format, and transmits the encoded data to the server via a secure communication protocol. By performing this resizing and compression on the terminal, the system reduces an amount of data to be transferred and reduces a load on server-side decoding, thereby improving communication efficiency.

The server receives the image data and stores the data in the storage device in association with a user identifier. The server loads the image into memory using an image-processing library such as a general-purpose computer vision library and converts the image into an internal matrix representation. The server applies a face detection algorithm, such as a histogram of oriented gradients-based detector or a convolutional neural network-based detector, to locate a face region. Then the server applies a facial landmark detector, such as a regressor trained to output landmark coordinates (for example, jawline, eyes, nose, mouth contours), and obtains a vector of landmark positions.

The server calculates feature values of a face shape by computing distances, ratios, and angles between landmark points. For example, the server computes a ratio of face width to face height, an angle of a jawline segment, a ratio of cheekbone width to jaw width, and a ratio of forehead height to overall face height. The server normalizes each feature to a predetermined scale and concatenates them into a face feature vector. The server feeds the face feature vector to a classifier implemented by a machine-learning library, such as a support vector machine or a small neural network trained with cross-entropy loss, to obtain a categorical face shape label (for example, round, oval, square). By mapping raw landmark coordinates to a compact feature vector and then to a category, the server reduces dimensionality and enables subsequent modules to operate on a low-dimensional representation, which improves computational efficiency and reduces memory footprint.

The server performs hair-region segmentation by executing a semantic segmentation neural network on the graphics processing unit. In one embodiment, the segmentation network has an encoder-decoder architecture similar to a U-shaped convolutional network, where the encoder comprises multiple convolution, normalization, and pooling layers, and the decoder comprises transposed convolution or upsampling layers. The network is trained on labeled images with pixel-level classes including hair, skin, and background. The server converts the input image into a tensor, applies mean normalization, and forwards the tensor through the network. The network outputs per-pixel class probabilities; the server selects the class with the highest probability for each pixel to produce a hair mask and a skin mask. The server computes average color vectors in a color space over the hair mask and maps these vectors to hair color categories using a rule-based mapping or a small classifier. This pixel-level segmentation and color mapping enable the server to derive hair attributes directly from the image without relying on human labeling or global heuristics, thereby improving accuracy in hair color and region estimation.

The terminal acquires a natural language input related to a desired hairstyle by presenting a text input field and a voice input function to the user. The user either enters text describing hairstyle preferences, or speaks a description that the terminal converts into text using a speech recognition service. The terminal packages the text with user identification information and sends it to the server. The server receives the text and performs morphological analysis using a morphological analyzer to segment the text into morphemes and assign part-of-speech tags. Subsequently, the server performs semantic analysis by applying a rule-based parser and/or a neural language model.

The server identifies tokens or phrases related to hairstyle attributes including length, shape, bangs, color, and impression. For example, the server detects phrases such as “shoulder-length,” “bob,” “side-swept bangs,” and “calm, mature impression.” A domain-specific dictionary maps such expressions to normalized attributes. The server constructs a hairstyle profile as a structured data record that stores attributes such as length category, shape category, presence or absence of bangs, bangs direction, color preference, impression tendency, and an estimated degree of image change. To estimate the degree of image change, the server uses a pre-trained neural language model, such as a transformer-based encoder, to embed the input text into a vector space and applies a regression head trained on examples labeled with change-intensity scores. The regression head is trained with a loss function such as mean squared error; training data augmentation methods, such as synonym replacement and paraphrasing, may be used to increase robustness. By generating a structured hairstyle profile from free-form natural language, the server allows downstream modules to operate on explicit attributes, which improves reproducibility and reduces ambiguity compared with systems that rely only on template matching.

The terminal also captures expression images of the user while the user interacts with hairstyle models. The terminal periodically obtains frames from the front-facing camera and sends these frames, along with an operation history including timestamps of candidate selections, switches, and viewing durations, to the server. The operation history is stored by the terminal in a local log structure and transmitted in batches to reduce network calls and to allow temporal analysis on the server side.

The server estimates an emotion state of the user based on the expression images, the natural language input, and the operation history. For expression images, the server uses an emotion recognition neural network implemented as a convolutional neural network with multiple convolutional and pooling layers followed by fully connected layers, trained to classify emotions such as joy, anxiety, confusion, and neutral. The network is trained using supervised learning with cross-entropy loss on labeled facial-expression datasets. The server computes emotion probabilities for each expression image, and aggregates these probabilities across time windows to obtain temporal emotion patterns.

For the natural language input, the server fine-tunes a language model as a sentiment or emotion classifier. The server feeds the text into the language model, obtains a feature embedding for the final layer, and applies a classification head to output scores for attributes such as positivity, negativity, and anxiety. For the operation history, the server calculates behavioral features including counts of candidate switches, maximum viewing time per candidate, median viewing time, frequency of back operations, and time to final decision. A rule-based engine and/or a recurrent neural network (for example, a long short-term memory network trained on sequences of interaction events) maps these behavioral features to a hesitation score.

The server integrates these three modalities using a fusion model. In one embodiment, the server concatenates the aggregated facial emotion vector, the text-based emotion vector, and the hesitation score into a single feature vector, and applies a fully connected neural network to output final emotion state scores. The network is trained with a multi-label or multi-class objective to produce a probability distribution over emotion states including anxiety, satisfaction, excitement, confusion, and indifference. This multi-modal fusion enables the server to identify emotion states with higher accuracy than any single modality alone, thereby improving the reliability of the emotion estimate used downstream.

The server constructs a prompt sentence for a generative artificial intelligence model based on the face shape feature values, hair feature values, the hairstyle profile, and the emotion state.

The server employs a template-based generator combined with dynamic insertion of attribute values. For example, when the face shape is classified as round, the current hair color is black, the hairstyle profile specifies shoulder-length bob, side-swept bangs, and mature impression, and the emotion state indicates strong anxiety, the server generates a prompt sentence such as: “User has a round face and currently has straight black hair of medium length. The user wants a shoulder-length bob with side-swept bangs and a mature, calm impression, but does not want a drastic change. Emotion analysis shows that the user feels anxious about a new hairstyle. Based on these conditions, generate three conservative bob styles that do not differ too much from the current hairstyle. Each style must be shoulder-length, with color ranging from black to dark brown, and natural side-swept bangs. Output three high-quality 3D hairstyle models (mesh and texture) that fit the user's face shape.”

In another situation where the emotion state indicates excitement or a challenging attitude, the server may generate a prompt sentence such as:

“The user has an oval face and currently has medium-length brown hair. The user wants to dramatically change the image and is willing to try bright colors and strong layers. Emotion analysis shows that the user is excited and open to bold changes. Based on these conditions, generate three hairstyle styles with a large degree of change, including bright hair color, dynamic layers, and noticeable movement at the hair ends. Output three high-quality 3D hairstyle models (mesh and texture) that fit the user's face shape.”

By algorithmically constructing such prompt sentences from structured attributes and emotion signals, the server changes the input to the generative artificial intelligence model in a systematic and state-dependent manner. This differs from manual prompt crafting and enables fine control over generative behavior, reducing unnecessary model runs that would otherwise yield irrelevant candidates.

The server passes the prompt sentence and face information of the user to the generative artificial intelligence model. In one embodiment, the generative artificial intelligence model is implemented as a conditional diffusion model, where a text encoder encodes the prompt sentence into an embedding, a separate encoder processes face information into another embedding, and a denoising network iteratively refines a noisy latent representation into a three-dimensional hairstyle representation. The denoising network may comprise a sequence of residual blocks and attention mechanisms, trained using a mean-squared-error or variational objective to reconstruct training examples from noise at multiple time steps. In another embodiment, the generative artificial intelligence model is implemented as a three-dimensional radiance field model conditioned on text, where a neural field maps coordinates and view directions, modulated by text and face embeddings, to density and color outputs. The server performs inference on the generative artificial intelligence model using the graphics processing unit. The server runs multiple sampling trajectories from different random seeds to generate a plurality of hairstyle variants in a single batched operation. Batched processing on the graphics processing unit reduces overhead and improves throughput relative to sequential generation. The model outputs three-dimensional hair geometry and associated texture maps. The server converts these outputs into a standardized data format such as a glTF format, by organizing vertex buffers, index buffers, normal vectors, material definitions, and texture images. The server compresses the data where appropriate to reduce transmission size to the terminal.

The server computes evaluation values for each generated three-dimensional hairstyle model using a recommendation algorithm. The server first extracts hairstyle attributes, such as length, volumetric distribution, bangs presence, and approximate color, from each generated model by analyzing the mesh geometry and texture information. The server then compares these attributes with the measured or estimated attributes of the user's current hairstyle to compute a degree of change. The server also applies a fit scoring model that receives both the face shape features and hairstyle attributes as input and outputs a suitability score. This fit scoring model can be implemented as a neural network trained on labeled examples where human raters judged how well hairstyles complement various face shapes.

The server modifies the weight assigned to the degree-of-change score based on the estimated emotion state. When the emotion state indicates anxiety or conservative preference, the server assigns higher penalty to large changes, effectively lowering scores for drastic styles. When the emotion state indicates excitement or challenging preference, the server relaxes or reverses this penalty, favoring more radical styles. The server computes a combined evaluation value as a weighted sum or as an output of a learned function that takes suitability score, degree-of-change score, and emotion-based weighting as inputs. This non-linear combination is designed and trained to maximize user satisfaction metrics collected from prior usage data. By adapting recommendation weights based on emotion, the server reduces an effective search space of hairstyles to those more aligned with the user's tolerance, which in turn reduces computational and rendering costs associated with low-value candidates.

The terminal receives ranked hairstyle candidates from the server and downloads corresponding three-dimensional models. The terminal uses a rendering engine to display each hairstyle model superimposed on the user's face image or a reconstructed head model.

The terminal aligns coordinate systems by matching facial landmarks or reference points such as the eyes and ears. This alignment minimizes manual adjustment by the user and improves visual accuracy of the simulation. Because models are delivered in a standardized and compressed format, rendering on resource-limited terminals is more efficient, which is critical for real-time user interaction.

The server also generates descriptive text for users and professionals. For user-facing descriptions, the server prepares a secondary prompt sentence containing conditions including face shape category, hairstyle attributes, and impression tendency, and sends this prompt to a generative text model. The generative text model, implemented as a transformer-based language model fine-tuned for short explanatory texts, outputs concise descriptions. For example, the server may obtain a description such as:

“A shoulder-length natural bob that softens the appearance of a round face and provides a calm, mature look without excessive change from your current style.”

For stylist-facing comments, the server generates a different prompt sentence including the hairstyle profile, emotion state, and user's current hairstyle description, and invokes the generative text model to produce professional guidance. Such comments may advise on points such as maintaining moderate change in length, adjusting layering to balance face proportions, or discussing color options with the client. By generating these texts automatically from structured data, the server reduces manual documentation and ensures consistent communication aligned with the data used by the generative model.

From a technical standpoint, the combination of modules deployed on the server improves computer functioning in multiple ways. First, by converting high-dimensional images and natural language inputs into compact feature vectors and structured profiles, the server reduces the volume and variability of data used by downstream generative and recommendation modules. This structured intermediate representation allows caching and reuse across sessions, thereby reducing redundant computation and latency. Second, the emotion-aware prompt generation and adaptive recommendation scoring reconfigure how the server invokes the generative artificial intelligence model, avoiding wasteful generation of obviously unsuitable hairstyles and focusing GPU cycles on promising regions of the hairstyle space. This selective invocation leads to a measurable reduction in GPU utilization and inference time per accepted candidate.

Third, the segmentation network, emotion recognition network, and recommendation network are trained and optimized with specific loss functions and data augmentation strategies tailored to this application, such as random cropping for robustness to framing errors, color jittering to handle lighting variation, and time-based augmentation for interaction sequences. These training techniques increase robustness and accuracy compared with naïve models, thereby reducing error-induced retries and re-renders. Fourth, the system introduces non-conventional processing flows, such as using user interaction logs as features for emotion estimation and using an image-change degree derived from language semantics as an explicit control parameter in generative prompting. These flows are not mere automation of human reasoning but constitute new computational rules that exploit correlations between multimodal signals and user acceptance of hairstyle changes.

The system can be realized in various alternative embodiments. For example, the segmentation model may be replaced by a transformer-based vision architecture with multi-head attention, the emotion recognition model may utilize graph convolutional layers on facial landmark graphs, and the generative artificial intelligence model may use different three-dimensional generation paradigms such as mesh-deformation networks. The hairstyle profile structure may include additional attributes such as preferred maintenance difficulty or styling time, and the prompt sentence may be extended to include these constraints. The recommendation algorithm may employ reinforcement learning to adjust scoring weights based on long-term user satisfaction data. Each of these variations remains within the scope of the disclosed invention, as long as the server generates and uses a prompt sentence for a generative artificial intelligence model based on integrated image, language, and emotion analysis to produce and rank three-dimensional hairstyle models that are adapted to both physical and emotional characteristics of the user.

In all embodiments, the server, the terminal, and the associated software cooperate to provide a computer-centric solution that reconfigures internal data structures, model invocation sequences, and scoring algorithms to achieve more accurate, faster, and resource-efficient generation and recommendation of three-dimensional hairstyle models than previously possible with simple template matching or manual prompt design.

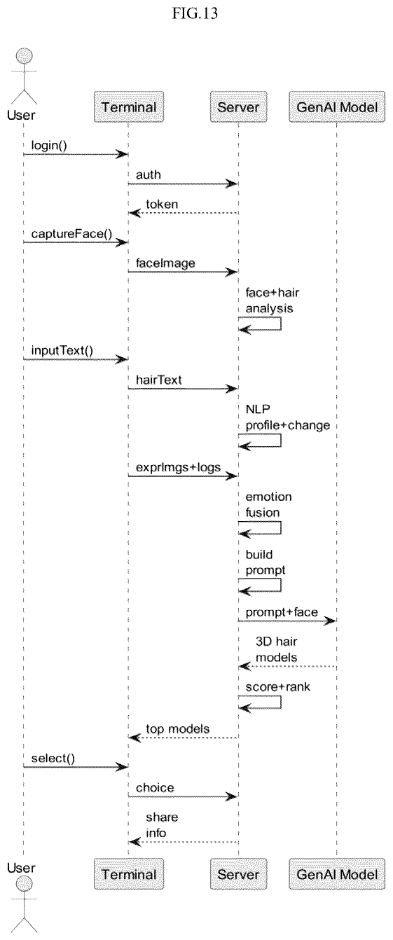

The following describes the processing flow using FIG. 13.

### Step 1:

Terminal displays an authentication screen and sends credentials.

Terminal uses a user interface framework to display fields for an identifier and a secret (for example, email and password) and a login button. User enters the identifier and secret and taps the login button. Terminal takes the entered secret as input, applies a cryptographic hash function to the secret, and constructs a request object that includes the identifier, the hashed secret, and device information as output. Terminal sends this request object to the server over a secure communication protocol.

### Step 2:

Server authenticates the user and issues a session token.

Server receives the authentication request as input, parses the identifier and hashed secret, and queries a user record in a storage system. Server compares the received hash with a stored hash value. Based on this comparison, server either rejects the request or generates a session token as output. Server stores the session token with an expiration timestamp and returns the token to the terminal. Terminal receives the token and stores it securely for subsequent requests.

### Step 3:

Terminal captures a head image of the user and transmits it.

Terminal, after successful authentication, displays a screen that invites the user to start hairstyle simulation. User taps a capture button. Terminal calls a camera application programming interface to start a preview stream from an imaging device and overlays a face-position guide frame on the preview. User aligns the head with the guide frame and taps a shutter control. Terminal uses the preview frame at that moment as input, resizes the frame to a predetermined resolution, compresses the resized frame into an image format, and produces encoded image data as output. Terminal attaches the session token and user identifier to a request object and transmits the encoded image data to the server.

### Step 4:

Server performs face detection and landmark extraction.

Server receives the encoded image and user identifier as input, decodes the image into a pixel matrix, and applies a face detection algorithm to locate one or more candidate face regions.

Server selects one region and then applies a landmark detection model to that region to obtain a set of facial landmark coordinates as output. Server calculates geometric values such as distances, ratios, and angles from these coordinates and stores the landmark coordinates and geometric values in association with the user identifier.

### Step 5:

Server computes face shape features and classifies face shape.

Server takes the geometric values from Step 4 as input, normalizes each value to a common numeric range, and concatenates the normalized values into a feature vector. Server feeds this feature vector to a classifier model and computes a probability distribution over a predefined set of face shape categories. Server selects the category with the highest probability as the face shape label. Server outputs the face shape label and the feature vector and stores them for later use.

### Step 6:

Server performs hair and skin segmentation and derives hair color.

Server takes the decoded image as input, converts the image into a tensor, and feeds the tensor to a segmentation network that outputs per-pixel class probabilities. Server selects the most likely class for each pixel and produces masks for hair and skin as output. Server applies the hair mask to the image to compute average color values for hair pixels and maps the average color to a discrete hair color category using a predefined mapping or classifier. Server stores the hair mask, skin mask, and hair color category associated with the user identifier.

### Step 7:

Terminal acquires a natural language hairstyle input from the user.

Terminal displays a hairstyle preference input screen with a text field and a voice input button. User either types a free-form description of a desired hairstyle or presses the voice input button and speaks. Terminal, in the text case, uses the typed string as input and in the voice case sends captured audio to a recognition service and receives recognized text as output. Terminal constructs a request object that includes the recognized or typed text and the session token and sends it to the server.

### Step 8:

Server performs morphological and semantic analysis of the text.

Server receives the hairstyle text as input, segments the text into tokens with a morphological analyzer, and assigns part-of-speech tags to each token. Server applies semantic rules and a domain dictionary to the token sequence to identify expressions related to length, shape, bangs, color, and impression. Server converts each expression into a normalized attribute value, such as a length category or a shape category, and constructs a structured hairstyle profile object as output. Server stores the hairstyle profile associated with the user identifier.

### Step 9:

Server estimates the degree of image change from the natural language input.

Server takes the same hairstyle text as input, encodes the text into a vector using a language model, and feeds the vector into a regression or classification head that outputs a numerical degree-of-change score. Server combines this score with the attributes created in Step 8 by adding fields to the hairstyle profile. The output is an enriched hairstyle profile that includes the degree-of-change attribute.

### Step 10:

Terminal captures expression images and logs interaction events.

Terminal displays an initial preview or placeholder while it waits for generated hairstyle models. When the preview screen is active, terminal periodically captures frames from a front-facing camera. Terminal uses each frame as input, resizes and encodes it, and stores the encoded expression images in a buffer. Terminal also records interaction events, such as candidate selection and viewing duration, in an operation log structure. Terminal sends the batch of expression images and operation logs to the server as output at predetermined intervals or when the user reaches a defined interaction point.

### Step 11:

Server performs emotion recognition from expression images.

Server receives expression images and user identifier as input and decodes each image into a tensor. Server passes each tensor through an emotion recognition network and obtains a probability vector for emotion categories. Server aggregates probabilities across time windows by calculating statistical measures, such as mean and maximum probabilities, for each emotion. Server outputs an aggregated facial emotion vector per user session.

### Step 12:

Server analyzes sentiment and emotion from the hairstyle text.

Server reuses or receives the hairstyle text as input and passes the text into an emotion classification model. Server obtains a score vector representing attributes such as positivity, negativity, and anxiety. Server uses this vector as output and stores it linked to the session.

### Step 13:

Server analyzes the operation history to compute a hesitation score.

Server receives the operation log as input, including timestamps and identifiers of user actions. Server computes features such as number of candidate switches, average and maximum viewing times, and time to any selection event. Server passes these features into a rules engine or a temporal model and computes a single hesitation score as output.

### Step 14:

Server fuses multimodal data to estimate a final emotion state.

Server takes as input the aggregated facial emotion vector from Step 11, the text-based emotion vector from Step 12, and the hesitation score from Step 13. Server concatenates these quantities into a combined feature vector and feeds this vector into a fusion network. The fusion network outputs a probability distribution over final emotion states and a selected emotion label as output. Server stores the emotion label and corresponding scores associated with the user identifier.

### Step 15:

Server constructs a prompt sentence for the generative AI model.

Server retrieves the face shape label, face feature vector, hair color category, hairstyle profile, and emotion state as input. Server inserts these values into a template or rule-based text generator. The generator produces a natural language prompt sentence that specifies conditions for hairstyle generation, such as length, shape, color range, and desired degree of change. For example, server may output the following prompt sentence:

“User has a round face and currently has straight black hair of medium length. The user wants a shoulder-length bob with side-swept bangs and a mature, calm impression, but does not want a drastic change. Emotion analysis shows that the user feels anxious about a new hairstyle. Based on these conditions, generate three conservative bob styles that do not differ too much from the current hairstyle. Each style must be shoulder-length, with color ranging from black to dark brown, and natural side-swept bangs. Output three high-quality 3D hairstyle models (mesh and texture) that fit the user's face shape.”

The server stores this prompt sentence as part of the session record.

### Step 16:

Server generates multiple 3D hairstyle models using the generative AI model.

Server takes the prompt sentence from Step 15 and face information (image or geometry) as input and encodes them into embeddings. Server provides these embeddings to a generative AI model configured to produce 3D hair geometry and texture. Server runs the model on a graphics processing unit and executes multiple sampling runs with varying seeds to generate several hairstyle variants. The model outputs, for each run, mesh data and texture images as output. Server converts these raw outputs into a standard model format, attaching material and texture references, and stores the models in persistent storage.

### Step 17:

Server extracts attributes from generated 3D hairstyle models.

Server reads each generated model file as input, parses its mesh and material data, and computes attributes such as approximate hair length, volume distribution, presence or absence of bangs, and dominant color. Server summarizes these attributes in a metadata record per model as output. This metadata is used for comparison with the current hairstyle and for subsequent scoring.

### Step 18:

Server computes degree-of-change and suitability scores for each model.

Server takes the metadata from Step 17 and the current hairstyle attributes from earlier analysis as input. For each candidate, server calculates numeric differences in length, color, and other attributes, and aggregates these differences to output a degree-of-change score. Separately, server feeds the face feature vector and model attributes to a suitability model that outputs a face-suitability score. Server stores each candidate's degree-of-change score and suitability score with the model identifier.

### Step 19:

Server combines emotion state with scores to compute evaluation values.

Server takes as input the degree-of-change score, the suitability score, and the emotion state label. Server applies a weighting rule or a learned function that adjusts the importance of the degree-of-change score according to the emotion state. For example, server increases weight on low change when the emotion state is anxious and increases weight on high change when the emotion state is excited. Server computes a single evaluation value per candidate as output, which quantifies the overall desirability of the model for the current user state.

### Step 20:

Server ranks the 3D hairstyle models and prepares presentation data.

Server takes the evaluation values and model identifiers as input, sorts the models in descending order of evaluation, and selects a subset of top candidates. Server compiles a response object that includes identifiers, standardized 3D model locations, and associated attributes for each selected model as output. Server sends this response object to the terminal.

### Step 21:

Terminal downloads and displays ranked hairstyle models.

Terminal receives the ranked candidate information as input and downloads the corresponding 3D model files from storage locations. Terminal loads each 3D model into a rendering engine and aligns each model with the user's face image or 3D head representation by using reference coordinates. Terminal renders each candidate on the display and presents controls to the user for switching, rotating, and zooming the model. The rendered images and user interface constitute the output of this step.

### Step 22:

User selects a preferred hairstyle candidate.

User observes the rendered 3D hairstyle models and interacts with the terminal to view multiple candidates. When the user finds a suitable hairstyle, the user taps a selection or confirmation control. Terminal receives the selected candidate identifier as input from the user's action and generates a selection record as output, which includes the candidate identifier and session token. Terminal sends this record to the server.

### Step 23:

Server prepares stylist-facing information and shares it.

Server receives the selection record as input, retrieves the selected 3D hairstyle model, the hairstyle profile, the face shape label, and the emotion state. Server then constructs a stylist-oriented prompt sentence that includes these items and passes the prompt to a text generation module. The module outputs a short comment describing key styling and counseling points. Server packages the selected model reference, user thumbnail, hairstyle profile, emotion state, and the generated comment into a data object as output. Server transmits this object to a terminal used by a beauty treatment provider, enabling the provider to view the selected hairstyle and associated emotion-aware information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional virtual try-on and recommendation systems executed by general-purpose computers typically generate an avatar or composite image based on static user attributes, such as a face image or body size, and then present a set of product options or generic explanatory text. In these systems, the processing executed by the processor is largely limited to simple image compositing, rule-based recommendation, and display control. As a result, such systems exhibit several technical limitations from the perspective of computer technology.

First, conventional systems do not deeply utilize dynamic user interaction signals, such as facial expressions captured during virtual try-on and detailed operation history on an information processing terminal, as machine-interpretable features for real-time computational inference. In many cases, only coarse interaction data, such as page views or clicks, are stored in a database and analyzed offline. The processor therefore cannot compute a fine-grained, integrated emotion state per user and per item in real time, and cannot adapt internal scoring and generation processes accordingly. This limits the system's capability to control computational resources and data flows in a manner that is sensitive to the user's moment-to-moment reaction, and results in a rigid recommendation flow that is not technically optimized for dynamic personalization.

Second, even when a generative AI model is available to produce natural language text, conventional systems typically rely on static or manually crafted prompts. The processor does not systematically generate prompt sentences by integrating multi-modal data, such as facial-expression-based emotion scores, behavior-based emotion indices, and product attribute data, into a structured, context-rich natural language instruction. Consequently, the generative AI model operates as a loosely coupled external component, and its internal inference is not closely guided by the system's real-time user state. This leads to outputs that are generic and not computationally aligned with the user's current emotional condition, reducing the technical effectiveness of the generative AI integration.

Third, conventional recommendation engines often treat emotional signals, if any, as auxiliary metadata rather than as primary computational signals that directly alter ranking scores and content generation behavior. The processor typically computes recommendation scores based on collaborative filtering or content similarity alone, and then merely filters or labels results. As a result, the internal decision logic of the recommendation process does not adaptively shift computational emphasis away from historically negative emotional responses and toward historically positive emotional responses at the granularity of item attributes, such as color, silhouette, or brand. This design reduces the technical efficiency of the recommendation process and can lead to redundant display of items that are likely to cause dissatisfaction or indecision, thereby increasing unnecessary computation and bandwidth.

Fourth, in a purchase flow, conventional systems do not use structured, integrated emotion state information to trigger context-specific natural language generation for reassurance or social sharing. The processor simply displays pre-defined, static explanations regarding return policy or size information, without tailoring the content or timing based on inferred anxiety or indecision levels computed from facial and behavioral signals. From a computer-technical standpoint, this prevents the system from using a systematic, state-dependent generation pipeline that changes server-side processing paths, prompt construction, and output routing as a function of real-time emotion state. As a result, the utilization of network bandwidth, processing time on the generative AI model, and UI screen real estate is not optimized. Accordingly, there is a need for an improved computer-implemented system in which a processor acquires facial expression images and detailed operation history from an information processing terminal during virtual try-on, computes integrated emotion state information by combining image recognition and behavior analysis models, and uses this integrated emotion state to drive both emotion-aware recommendation scoring and dynamic construction of prompt sentences for a generative AI model. There is a further need for a system in which the processor, based on integrated emotion state thresholds, selectively generates reassurance-oriented explanations during purchase and concise sharing messages for external information sharing services, thereby improving the technical functioning of the server-side processing pipeline, the interaction with the generative AI model, and the adaptive control of information displayed on the terminal.

The specific processing by the specific processing unit 290 of the data processing device 12 in Application Example 2 is realized by the following means.

The present invention provides a server comprising a processor configured to acquire, from an information processing terminal, image information including a face region of a user and body attribute information relating to the user; to extract facial feature information from the image information, generate model information representing a virtual object corresponding to the user based on the facial feature information and the body attribute information, and synthesize the model information with three-dimensional shape information corresponding to an apparel article or an accessory to generate display information for virtual fitting; to control the information processing terminal to display the display information for virtual fitting and, during a period in which the display information for virtual fitting is displayed, acquire, from the information processing terminal, image information including an expression of the user and operation history information relating to an operation on the information processing terminal by the user; to execute image recognition processing based on the image information including the expression of the user and execute behavior analysis processing based on the operation history information, calculate emotion state information of the user, and generate integrated emotion state information by integrating a result of the image recognition processing and a result of the behavior analysis processing; to select candidate information of the apparel article or the accessory to be presented to the user based on selection history information and purchase history information relating to the user, the integrated emotion state information, and product attribute information relating to the apparel article or the accessory, and calculate priority information for the candidate information; and to construct, in a natural language format, a prompt sentence to be input to a generative artificial intelligence model based on the integrated emotion state information, the selection history information, the purchase history information, and the product attribute information relating to the candidate information, transmit the prompt sentence to the generative artificial intelligence model via a communication interface, acquire natural language text information output from the generative artificial intelligence model in response to the prompt sentence, and output the natural language text information to the information processing terminal. This enables the processor to dynamically adjust internal recommendation scoring and generative text output in real time based on multi-modal, integrated emotion state information, thereby improving the technical operation of the virtual fitting and recommendation system, optimizing server-side processing and network usage, and providing emotion-adaptive explanations and prompts that are computationally tailored to the user's current interaction state.

The term “information processing terminal” refers to an electronic computing apparatus operated by a user, the apparatus including at least a display, an input interface, a communication interface, and a processing circuit, and being configured to transmit and receive data to and from a server via a communication network.

The term “image information including a face region of a user” refers to digital image data representing at least a portion of a user's face, the data being obtainable by an imaging device of an information processing terminal and including pixel values sufficient for detection of facial features.

The term “body attribute information” refers to attribute data relating to a physical characteristic of a user, the data including at least one of height, weight, body type category, gender, age group, or similar anthropometric information that is usable for generation or adjustment of a virtual model.

The term “facial feature information” refers to numerical or symbolic data derived from analysis of image information including a face region, the data representing positions, shapes, or relationships of facial components such as eyes, nose, mouth, jawline, and eyebrows, and being suitable for use as an input to a model-generation process.

The term “model information representing a virtual object corresponding to the user” refers to digital data defining a graphical representation of a virtual entity associated with the user, the data including at least geometry parameters, texture parameters, and configuration parameters that allow rendering of an avatar or similar object.

The term “three-dimensional shape information” refers to digital data defining a three-dimensional structure of an article, the data including at least vertices, edges, faces, and associated attributes such as material or texture coordinates, and being usable for three-dimensional rendering or simulation.

The term “apparel article” refers to a wearable item intended to be worn on a human body, including at least upper garments, lower garments, one-piece garments, footwear, headwear, bags, and similar fashion items.

The term “accessory” refers to a wearable or carryable item that complements an apparel article, including at least jewelry, belts, bags, scarves, hats, and similar items.

The term “display information for virtual fitting” refers to digital data generated by combining model information representing a virtual object corresponding to the user with three-dimensional shape information corresponding to an article, the data being configured so that an information processing terminal can render an image or animation showing the virtual object wearing the article.

The term “operation history information” refers to time-series data representing user interactions with an information processing terminal, the data including at least event types, timestamps, target objects, and screen stay durations.

The term “image recognition processing” refers to a computational procedure in which a processor analyzes image information using an algorithm or model to detect or classify patterns, and in particular, to estimate a state such as a facial expression of the user from the image information.

The term “behavior analysis processing” refers to a computational procedure in which a processor analyzes operation history information using an algorithm or model to estimate behavioral tendencies or states of a user, including at least interest level, indecision level, or dissatisfaction level.

The term “emotion state information” refers to data representing an estimated psychological or affective state of a user with respect to an item or screen, the data including at least one emotion type and an associated intensity value.

The term “integrated emotion state information” refers to emotion state information obtained by combining results of image recognition processing and behavior analysis processing, the information representing a unified estimation of a user's emotional condition.

The term “selection history information” refers to data indicating items that have been previously viewed, selected, or virtually tried on by a user, the data being indexed over time.

The term “purchase history information” refers to data indicating items previously purchased by a user, including at least item identifiers, purchase dates, and quantities.

The term “product attribute information” refers to data describing properties of an article, including at least a product identifier, category, color, size, price, brand type, material, and stock status.

The term “candidate information of the apparel article or the accessory” refers to data specifying one or more articles selected by a processor as potential recommendations to be presented to a user.

The term “priority information” refers to ranking data or score data associated with candidate information, the data representing a relative preference or display priority computed by a processor.

The term “generative artificial intelligence model” refers to a machine learning model configured to generate output data such as natural language text in response to input data, the model including at least a neural network trained on sample data.

The term “prompt sentence” refers to a natural language instruction or query constructed to be input to a generative artificial intelligence model, the sentence specifying at least conditions, constraints, or desired content of an output to be generated by the model.

The term “natural language text information” refers to textual data expressed in a human language, such as sentences or paragraphs, the data being generated by a generative artificial intelligence model or other text generation process.

The term “settlement processing information” refers to data used by a processor to perform payment processing for a purchase transaction, including at least payment amount data, payment method data, and transaction identifier data.

The term “inventory update information” refers to data used to modify item stock records in a storage system in response to a purchase transaction, the data including at least item identifiers and quantity changes.

The term “order registration information” refers to data used to create or update an order record in an order management system, the data including at least user identifiers, item identifiers, quantities, prices, and shipping information.

The term “trained image recognition model” refers to a machine learning model that has been trained using image data and configured to output classification results or probability values for one or more classes based on input image information.

The term “facial-expression-based emotion score information” refers to numerical data including at least a probability value or intensity value for each of a plurality of emotion types, the data being calculated by applying a trained image recognition model to image information including a user's expression.

The term “feature information” refers to numerical or categorical values derived from raw operation history information, the values being used as input variables for a behavior analysis model.

The term “behavior analysis model” refers to a machine learning model or algorithm that receives feature information derived from operation history information and outputs behavior-based emotion index information or related indices.

The term “behavior-based emotion index information” refers to numerical data indicating estimated emotional tendencies of a user that are derived from behavioral patterns, including at least indices of interest, indecision, or dissatisfaction.

The term “weighted calculation” refers to a numerical operation in which multiple input values are combined by applying respective weights and summing or otherwise aggregating the weighted values.

The term “rule-based calculation” refers to a computational procedure in which input values are combined or transformed according to predetermined logical rules to produce an output value.

The term “return-condition information” refers to data describing conditions under which a purchased article may be returned, including at least return period, eligibility criteria, and cost conditions.

The term “size-exchange-condition information” refers to data describing conditions under which an article may be exchanged for a different size, including at least exchange period, applicable items, and procedural steps.

The term “styling-versatility information” refers to descriptive data indicating usability of an article in combination with other articles or across multiple occasions or seasons.

The term “supplementary explanation information on a purchase screen” refers to natural language text information presented on a user interface associated with a purchase process, the information being configured to provide additional guidance, reassurance, or clarification to the user.

The term “sharing short message” refers to a short natural language text suitable for posting to an external information sharing service, the text being generated based on user state and item information.

The term “external information sharing service” refers to a network-based service that allows users to publish or share content with other users, including at least social networking services, messaging platforms, or microblogging services.

The term “posting candidate information” refers to text or related data proposed by a system as a candidate for user posting to an external information sharing service.

In one embodiment, a system includes a server and one or more terminals connected via a communication network. The server includes at least one processor, a main memory, a non-volatile storage device, and a communication interface. The server optionally includes a graphics processing unit configured to accelerate matrix operations for image recognition and neural network inference. The terminal includes at least one processor, a display, an imaging device, an input interface such as a touch panel, and a communication interface. The server and the terminal execute software modules implementing the functions described below.

The server executes an operating system suitable for server use, an image processing library, a machine learning framework, a database management system, and an interface module for accessing a generative AI model. The image processing library includes functions equivalent to those provided by a generic image processing toolkit, for example, functions for resizing, filtering, and color-space conversion. The machine learning framework includes functions equivalent to those provided by general-purpose deep learning frameworks, such as tensor operations, automatic differentiation, and model serialization. The database management system manages product data, user history data, and emotion state data. The interface module transmits and receives text data to and from an external or internal generative AI model via a network protocol.

The terminal executes an operating system for portable computing devices, a camera control module, a 3D rendering engine, and a client application. The camera control module uses a platform camera API provided by the operating system to control the imaging device. The 3D rendering engine executes vertex transformations, rasterization, and shading to display an avatar and virtual garments. The client application communicates with the server, acquires and displays virtual try-on images, and sends user interaction logs to the server.

The server acquires a face image of a user and body attribute information through the terminal. The terminal controls the imaging device via the camera control module and obtains image frames as pixel arrays. The terminal downsamples and compresses the image data and transmits the compressed data to the server via a secure transport protocol. The server stores the received data in the storage device and loads the data into the main memory for processing.

The server applies the image processing library to the face image. The server performs a sequence of operations, including noise reduction using a convolutional filter, resizing to a fixed resolution to create a uniform input size, and conversion to a normalized color space.

The server then invokes a facial landmark detection model. The facial landmark detection model is implemented as a convolutional neural network or a combination of convolutional and fully connected layers. The network receives the normalized image tensor as input and outputs coordinates of multiple keypoints, such as eye corners, nose tip, mouth corners, and jawline vertices.

The server transforms the keypoint coordinates into facial feature information. The server normalizes the coordinates by translating and scaling them so that global position and size differences are removed, and concatenates the normalized coordinates into a feature vector.

The server optionally expands the feature vector by appending derived values, such as distances between keypoints and angle values between segments connecting keypoints. The resulting facial feature vector is stored in memory and used as input to an avatar generation model.

The server also processes body attribute information obtained from the terminal. The body attribute information includes categorical and numerical values such as height, weight, gender, and body type labels. The server encodes the body attribute information as a fixed-length feature vector by normalizing numerical attributes and one-hot encoding categorical attributes. The server inputs this feature vector to a body type classification model implemented with a machine learning library. The body type classification model may be realized as a tree-based ensemble or a shallow neural network. The model outputs a body type category and scale parameters for body parts. These scale parameters specify multiplicative factors for torso height, leg length, shoulder width, and waist width.

The server uses a neural avatar generation model to generate model information representing a virtual object corresponding to the user. In one embodiment, the neural avatar generation model is implemented as an encoder-decoder architecture. The encoder receives the facial feature vector and the body scale parameters and maps them into a latent representation in a continuous vector space. The decoder receives the latent vector and outputs parameter sets for a face mesh, a body mesh, and associated textures. The decoder network includes multiple fully connected layers for global parameters and convolutional layers for texture maps. The model is trained in advance using a training dataset of human face images, body attribute labels, and target avatar parameters. The training process uses a loss function that combines reconstruction error of 3D geometry, texture similarity, and regularization terms. The server uses gradient-based optimization methods to minimize the loss function during the training phase, and stores the trained weights in the storage device.

The server loads a base avatar mesh from the storage device. The base avatar mesh is defined as a set of vertices, faces, and a skeleton for deformation. The server applies the generated shape parameters as linear blendshape weights or bone-scale coefficients. The server performs vector-matrix multiplications to transform vertex positions of the base mesh into a customized avatar geometry. The server applies texture images generated by the decoder network onto the mesh using standard texture mapping techniques. The resulting model information is exported as a 3D model file in a common format and stored. The server transmits the model file to the terminal via the communication interface.

The terminal receives the model file and loads it into the 3D rendering engine. The terminal initializes a virtual camera and light sources and renders the avatar on the display. The terminal updates camera position and orientation in response to user input events such as touch gestures. The terminal performs perspective projection, vertex shading, and pixel shading to render the avatar from different viewpoints.

The server stores three-dimensional shape information corresponding to apparel articles and accessories in the storage device. Each article is represented by a 3D mesh, material parameters, and size parameters. The server also stores product attribute information, such as category, color, and fabric type, in the database. When the terminal requests a virtual try-on for a selected article, the server retrieves the corresponding 3D mesh and attribute information, and retrieves the avatar model associated with the user.

The server performs a mesh fitting process that associates the garment mesh with the avatar mesh. The server maps garment skeleton joints to avatar skeleton joints. The server computes transformation matrices for garment bones by combining avatar joint transformations with garment-specific offsets. The server applies skinning operations to the garment mesh, adjusting vertex positions using linear blend skinning or dual quaternion skinning. The server also modifies garment scale using the size parameters and the avatar-scale parameters to achieve a realistic fit. In another embodiment, the server uses a physics simulation module to simulate the drape and movement of the garment under gravity and avatar motion, updating vertex positions over time.

The server synthesizes the avatar mesh and garment mesh into combined scene data. The server may render images on the server side and transmit compressed images to the terminal, or may transmit combined mesh data to the terminal for rendering. By performing the mesh fitting and combination on the server, the system can use higher-precision simulation and reduce computational load on the terminal.

During virtual fitting, the terminal captures image information including an expression of the user using the imaging device. The terminal periodically acquires frames, resizes them to a lower resolution to reduce bandwidth, compresses them, and transmits the compressed frames with metadata identifying the current item and time. The terminal also logs operation history information, including event type, target item identifier, timestamp, and screen stay duration, and transmits this information to the server at predetermined intervals.

The server executes image recognition processing on the expression images. The server uses a trained image recognition model implemented with a deep learning framework. In one embodiment, the model is a convolutional neural network including several convolutional layers, pooling layers, and fully connected layers. In another embodiment, the model is a vision transformer that segments the image into patches, embeds the patches into a sequence of vectors, and processes the sequence via self-attention layers. The output layer of the model produces a probability distribution over multiple emotion classes. The server calculates facial-expression-based emotion score information by aggregating per-frame probability vectors associated with the same item. The server uses weighted averaging based on frame timestamps or confidences to generate a stable emotion score for each emotion type.

The server executes behavior analysis processing on the operation history information. The server aggregates events by item and session, and computes feature information such as total stay time, number of revisits, frequency of rapid exits, and presence of add-to-cart events. The server stores the feature vectors in memory and inputs them to a behavior analysis model. The behavior analysis model may be realized as a gradient-boosted decision tree or a feedforward neural network. The model outputs behavior-based emotion index information, such as interest level, indecision level, and dissatisfaction level, as scalar values between zero and one.

The server generates integrated emotion state information by combining the facial-expression-based emotion score information and the behavior-based emotion index information. In one embodiment, the server applies weighted calculation, where weights are predetermined or adaptively learned. The server multiplies each component of the facial-expression-based emotion score vector and behavior-based index vector by corresponding weights, and sums them to obtain an integrated value. In another embodiment, the server applies rule-based calculation, in which specific combinations of patterns trigger adjustments. For example, if facial joy is high but behavior indicates repeated revisits without purchase, the server increases indecision level. These non-conventional combination rules differ from simple human judgment and allow the computer to derive a nuanced integrated emotion state that humans would find difficult to compute consistently in real time.

The server stores the integrated emotion state information in the database, indexed by user and item identifiers. The server also stores selection history information and purchase history information, each record containing user identifiers, item identifiers, timestamps, and associated integrated emotion values. The server later uses these stored data to perform recommendation and prompt construction.

The server performs recommendation processing using the integrated emotion state information. The server retrieves, for a target user, candidate items determined by a base recommendation algorithm. The base algorithm may use collaborative filtering, content-based filtering, or a hybrid approach. The server computes a base score for each candidate item based on similarity in product attribute information and historical co-selection patterns. The server then modifies the base scores using emotion-related parameters. If the integrated emotion state information indicates that the user had high dissatisfaction for items with certain colors or silhouettes, the server reduces the scores for similar items. If the integrated emotion state information indicates that the user had high joy and interest for items in a specific category or brand type, the server increases the scores for similar items. The server computes priority information for each candidate by combining the base score with emotion-based adjustments, and sorts the candidates accordingly. This process not only changes the user-facing ranking but also causes the processor to avoid repeatedly computing and transmitting data for items likely to be rejected, thereby reducing unnecessary computation and communication load.

The server constructs prompt sentences for a generative AI model using the integrated emotion state information. The server collects data relevant to the current situation, including current item description, user body attributes, historical high-joy items, historical high-dissatisfaction items, and current integrated emotion values such as interest, indecision, and joy. The server converts each piece of structured data into a partial natural language phrase. For example, the server converts height and body type into a phrase such as “Height 160 cm, body type: standard,” and converts an emotion vector into a phrase such as “Emotion state: interest 0.8, indecision 0.6, joy 0.5, dissatisfaction 0.1.” The server concatenates these partial phrases and adds an instruction phrase specifying the purpose of the generation.

In one example, the server generates a style recommendation prompt sentence as follows:

“Based on the following user history data, please recommend the best styles for this user.

[User information] Height 160 cm, body type: standard

[Current try-on item] Light blue spring dress

[Emotion state] interest 0.8, indecision 0.6, joy 0.5, dissatisfaction 0.1

[History] Items with high joy in the past: A-line skirt, tapered pants

Please propose 3 spring styles in Japanese that reduce indecision, naturally cover the body shape, and keep a light spring mood.”

In another example, the server generates a reassurance prompt sentence for purchase:

“The user is about to buy a light blue spring dress online. The emotion engine shows that the user feels joy but is slightly anxious about size and returns. Please generate a Japanese explanation of about 200 characters that gives reassurance, emphasizes the easy return policy and size exchange, and mentions that the dress is easy to style with other items.” In another example, the server generates a sharing message prompt sentence:

“Generate a friendly Japanese message within 50 characters for SNS to show a light blue spring dress that the user really likes. The user wants to ask friends ‘What do you think?’ and the tone should be casual and cheerful.”

The server transmits the constructed prompt sentence to the generative AI model through the interface module. The generative AI model is a neural network configured for language generation. In one embodiment, the generative AI model is a transformer with multiple self-attention layers. The model is trained on large-scale text corpora using an autoregressive loss function that minimizes prediction error of the next token. The model parameters are optimized using gradient-based methods. The generative AI model receives the prompt sentence as a sequence of token embeddings, processes the sequence through multiple transformer layers, and outputs probability distributions over the next token at each step. The model generates text by sampling tokens according to these probabilities, subject to constraints such as maximum length and temperature.

The server receives the generated text from the generative AI model. The server optionally performs post-processing on the text, such as truncation, removal of disallowed content, or extraction of structured attributes via pattern matching. The server stores the generated text in memory and eventually in the storage device. The server sends the generated text to the terminal to be displayed as part of style explanations, reassurance messages, or sharing suggestions.

In one embodiment, the server detects cases where the integrated emotion state information indicates high anxiety or indecision levels. The server then constructs a prompt sentence that explicitly instructs the generative AI model to emphasize return-condition information, size-exchange-condition information, and styling-versatility information. The generated text is displayed on the purchase screen near the confirmation button. This dynamic behavior differs from static human-written disclaimers and allows the server to allocate generative AI computation only when emotion thresholds are exceeded, thereby improving computational efficiency.

In another embodiment, the server detects cases where the integrated emotion state information indicates high joy levels. The server constructs a prompt sentence that instructs the generative AI model to produce a short, friendly message suitable for an external information sharing service. The generated message is displayed by the terminal as a posting candidate. The server thereby uses emotion signals not only for ranking but also for controlling the content and timing of generative AI calls, contributing to reduction of unnecessary model invocations and network traffic.

The server also performs purchase processing. The terminal transmits purchase instruction information including selected items, shipping address, and payment method. The server constructs settlement processing information and communicates with an external payment service via an application programming interface. The server updates stock records in the database using inventory update information and creates order records using order registration information. The server transmits the result of the purchase, including order identifiers and expected delivery information, to the terminal.

The described architecture is not limited to a particular hardware platform or software library. The server may distribute different functions, such as image recognition, behavior analysis, recommendation computation, and generative AI interface, among multiple physical machines or virtual instances. The terminal may be a smartphone, a tablet, a notebook computer, or another portable computing device. The generative AI model may be deployed on the same server or may be provided as an external cloud service. In another embodiment, part of the emotion estimation processing may be executed on the terminal if the terminal has sufficient computational resources.

By using the described data structures and processing flows, the system achieves technical improvements beyond mere automation of human cognitive tasks. Because the server computes integrated emotion state information from both facial images and fine-grained operation logs, the emotion estimation is more accurate and robust than conventional methods relying on coarse click data alone. Because the server adjusts recommendation scores and generative text behavior based on these multi-modal signals, the server reduces redundant computations for items likely to be rejected and prioritizes items that historically produce positive reactions, thereby improving computation efficiency and reducing communication bandwidth. Furthermore, by constructing prompt sentences in a structured, state-dependent manner, the server constrains the generative AI model to operate within a well-defined context, improving the relevance and consistency of the generated text, and reducing the need for post-processing or repeated requests.

The server implements non-conventional combination rules and weighting strategies in integrating facial-expression-based scores and behavior-based indices. These rules define, for example, how to raise indecision values when certain patterns of facial and behavioral signals co-occur, or how to down-weight facial signals when camera confidence is low. Such rules cannot be easily replicated by simple manual heuristics and represent specific technical logic that modifies internal data paths. As a result, the processor achieves lower error rates in emotion classification and more stable recommendation behavior, leading to improved user interaction quality and system performance.

Although several embodiments have been described, various modifications are possible. The emotion classes used by the system may be changed or expanded. The network architectures for the facial expression model and the behavior model may be replaced by alternative structures, such as recurrent networks or graph neural networks. The prompt construction logic may be extended to include additional contextual parameters, such as time of day or device type. The described components may be implemented in hardware, software, or a combination. All such variations are intended to be within the scope supported by the claims.

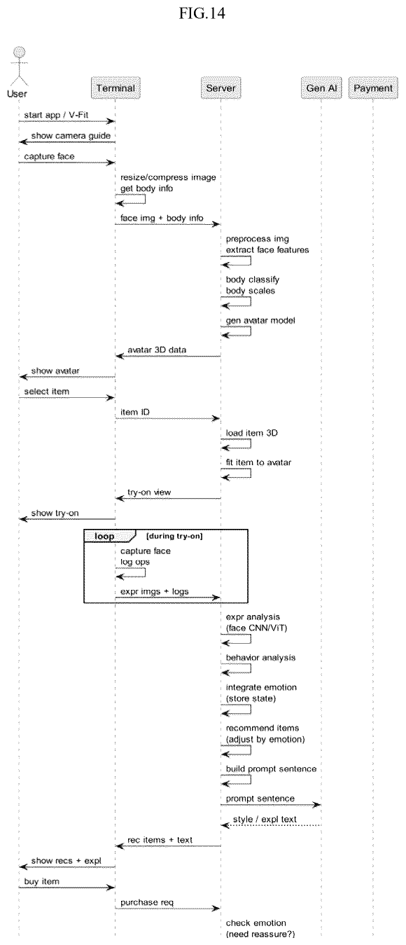

The following describes the processing flow using FIG. 14.

### Step 1:

User operates the terminal to start a virtual fitting session.

Terminal receives, as input, a user action such as launching the client application and selecting a virtual fitting menu. Terminal calls a camera API provided by the operating system to activate the front-facing imaging device and overlays a face guide frame and an instruction message on the display. Terminal outputs a live preview stream to the display for alignment of the user's face.

### Step 2:

User adjusts the face position according to the guide and performs a capture operation.

Terminal receives, as input, a shutter action from the user (for example, a tap on a capture button). Terminal acquires a frame from the imaging device as raw pixel data, performs data processing including resizing to a predefined resolution and color-space normalization, and executes JPEG compression. Terminal outputs compressed face image data representing the user's face region.

### Step 3:

Terminal acquires body attribute information from the user.

Terminal receives, as input, user entries for height, weight, gender, and other body attributes through form fields or selection controls. Terminal converts the entered values into a structured parameter set, performs simple validation (for example, range checking and type checking), and encodes the parameters into a standardized format. Terminal outputs body attribute information associated with the user.

### Step 4:

Terminal transmits user-related data to the server.

Terminal receives, as input, the compressed face image data and the body attribute information created in Steps 2 and 3. Terminal combines these into a request payload, including identifiers, timestamps, and device information, and encrypts the payload using a secure communication protocol. Terminal outputs a network request containing the user's face image and body attribute information and sends it to the server.

### Step 5:

Server receives and stores the user-related input data.

Server receives, as input, the network request from the terminal including the compressed face image data and the body attribute information. Server decrypts the payload, verifies integrity, and temporarily stores the image data and attribute data in a storage device. Server outputs preprocessed data objects representing the face image file path and the structured body attribute record in memory for further processing.

### Step 6:

Server performs image preprocessing and facial feature extraction.

Server receives, as input, the face image file path. Server loads the image into memory and applies an image processing library to perform noise reduction, resizing to a fixed resolution, and color-space conversion. Server then applies a facial landmark detection model, which operates as a trained neural network, to the normalized image. Server executes numerical operations to detect and output coordinates for multiple facial keypoints. Server converts the keypoint coordinates into a facial feature vector by normalizing the coordinates and concatenating them into a single multidimensional vector. Server outputs facial feature information suitable for avatar generation.

### Step 7:

Server analyzes body attribute information and generates body scale parameters.

Server receives, as input, the body attribute record from the terminal. Server normalizes numerical values (such as height and weight) and converts categorical values (such as gender and body type labels) into numeric codes. Server inputs these normalized values into a body type classification model implemented with a machine learning library. Server executes the model, which applies learned decision boundaries or decision trees, to output a body type category and numerical body scale parameters for relevant body parts. Server outputs the body type category and body scale parameters as a structured parameter set.

### Step 8:

Server generates avatar model information based on facial and body parameters.

Server receives, as input, the facial feature information and the body scale parameters from Steps 6 and 7. Server inputs these data into an avatar generation neural network, which performs matrix multiplications and non-linear activation operations layer by layer to compute a latent representation and then decode it to avatar parameters. Server outputs face shape parameters, body shape parameters, and texture parameters. Server then loads a base avatar mesh from storage and applies the shape parameters to deform vertices and adjust bone scales using linear algebra operations. Server applies the generated texture parameters onto the mesh using texture mapping. Server outputs complete avatar model information, including mesh data and texture data.

### Step 9:

Server transmits avatar model information to the terminal.

Server receives, as input, the avatar model information created in Step 8. Server serializes the model information into a 3D file format and stores it temporarily in a file or buffer. Server constructs a response message that includes the serialized model file and necessary metadata such as model version and units. Server outputs the response message and sends it to the terminal via the communication interface.

### Step 10:

Terminal receives and renders the avatar.

Terminal receives, as input, the avatar model file from the server. Terminal parses the file, loads the mesh and texture data into the 3D rendering engine, and initializes a scene with a virtual camera and lighting. Terminal performs vertex transformations, projection, and rasterization to generate image frames. Terminal outputs rendered frames to the display so that the user can see the avatar.

### Step 11:

User manipulates the view of the avatar.

Terminal receives, as input, interactive gestures from the user, such as touch, drag, and pinch on the display. Terminal translates each gesture into transformations (for example, rotation angles, zoom factors, and pan offsets) of the virtual camera or the avatar model. Terminal applies matrix operations to update the view matrix and projection matrix and re-renders the scene using the updated parameters. Terminal outputs updated frames, allowing the user to inspect the avatar from multiple viewpoints.

### Step 12:

User selects an apparel article or accessory for virtual fitting.

Terminal receives, as input, a user selection of an item from a list or catalog displayed on the screen. Terminal extracts the selected item's identifier and other metadata from the user interface components. Terminal logs the selection event with timestamp and context and packages the item identifier into a request payload. Terminal outputs a virtual try-on request including the item identifier and user identifier, and sends it to the server.

### Step 13:

Server retrieves three-dimensional shape information for the selected article.

Server receives, as input, the virtual try-on request with the item identifier. Server queries a product database using the item identifier and retrieves the corresponding product attribute record and reference to the 3D mesh file. Server loads the garment or accessory mesh, material parameters, and size parameters from storage into memory. Server outputs three-dimensional shape information and product attribute information for the selected article.

### Step 14:

Server fits the article onto the avatar and generates virtual fitting data.

Server receives, as input, the avatar model information and the three-dimensional shape information of the article. Server maps garment bones or anchoring points to corresponding avatar bones or surface regions, and computes transformation matrices for each garment bone based on the avatar pose and body scale parameters. Server applies skinning operations to transform garment vertices and adjusts overall scale using the size parameters. Optionally, server executes a cloth simulation step to refine vertex positions under physical constraints. Server outputs combined mesh or scene data representing the avatar wearing the article.

### Step 15:

Server transmits virtual fitting display data to the terminal.

Server receives, as input, the combined scene data from Step 14. Server either renders image frames on the server side, compresses them (for example, to JPEG or video), and embeds them in a response, or serializes the combined mesh for client-side rendering. Server constructs a response message containing the display data and sends it to the terminal. Server outputs virtual fitting display data as network response content.

### Step 16:

Terminal displays the virtual fitting result.

Terminal receives, as input, the virtual fitting display data from the server. If the data is an image sequence, terminal decodes and displays the images frame by frame. If the data is combined mesh data, terminal loads the mesh into the 3D engine and renders it with the existing scene settings. Terminal outputs the visual representation of the avatar wearing the selected article to the display.

### Step 17:

Terminal captures expression images and logs operation history during fitting.

Terminal receives, as input, a timer or scheduling signal that indicates capture intervals. Terminal uses the camera API to acquire frames of the user's face as pixel data while the virtual fitting result is displayed. Terminal resizes and compresses each frame and attaches metadata including the current item identifier and timestamp. Terminal also records operation history information such as screen changes, item switches, and interaction durations in a log structure. Terminal outputs expression image packets and operation history logs and transmits them to the server periodically.

### Step 18:

Server performs image recognition to compute facial-expression-based emotion scores.

Server receives, as input, the expression image packets from the terminal. Server loads each image into memory, optionally performs normalization, and feeds the image to a trained image recognition model. The model performs matrix multiplications and non-linear activations in multiple layers to output a probability vector over emotion classes. Server groups probability vectors by item and time window and performs weighted averaging across frames to smooth noise. Server outputs facial-expression-based emotion score information for each item, including probability values for multiple emotion types.

### Step 19:

Server performs behavior analysis to compute behavior-based emotion indices.

Server receives, as input, operation history logs from the terminal. Server parses each log entry, associates events with item identifiers and sessions, and aggregates statistics such as total stay time, number of re-views, immediate exits, and cart additions. Server constructs feature vectors by placing these statistics into fixed-length arrays. Server inputs these feature vectors into a behavior analysis model, which executes decision-tree or neural-network calculations to produce emotion indices. Server outputs behavior-based emotion index information, such as interest level, indecision level, and dissatisfaction level for each item.

### Step 20:

Server integrates multi-modal emotion information into integrated emotion state information.

Server receives, as input, the facial-expression-based emotion score information and the behavior-based emotion index information for each item. Server applies an integration algorithm that combines these values by weighted sums or conditional rules. For weighted sums, server multiplies each component by a predetermined or learned weight and sums them to obtain integrated values. For rule-based integration, server applies logic such as increasing indecision when high joy co-occurs with frequent re-views without purchase. Server outputs integrated emotion state information, represented as a vector of emotion levels for each item and user.

### Step 21:

Server stores emotion states and user histories.

Server receives, as input, the integrated emotion state information, current item identifiers, and user identifiers. Server writes records containing user identifiers, item identifiers, timestamps, and integrated emotion values into a database table. Server also updates selection history information and purchase history information using new events or purchases. Server outputs updated database records that can be referenced by subsequent recommendation and generation processes.

### Step 22:

Server computes emotion-aware recommendation scores.

Server receives, as input, the updated selection history information, purchase history information, integrated emotion state information, and product attribute information. Server uses a base recommendation algorithm to compute a similarity or collaborative score for candidate items. Server then modifies these base scores by applying adjustments derived from integrated emotion patterns, such as down-weighting items similar to those with high dissatisfaction and up-weighting items similar to those with high joy. Server aggregates base scores and adjustments into final scores. Server outputs recommendation scores and a ranked list of candidate items.

### Step 23:

Server constructs a prompt sentence for a generative AI model.

Server receives, as input, the integrated emotion state information, ranked candidate items, user body attributes, and historical emotion patterns. Server transforms each structured value into a natural language fragment, such as text describing height, body type, current item, and emotion levels. Server concatenates the fragments and appends an instruction describing the desired output, such as “propose 3 styles” or “generate a reassuring explanation.” Server builds a single text string as a prompt sentence. Server outputs the prompt sentence as a natural language instruction for a generative AI model.

### Step 24:

Server sends the prompt sentence to the generative AI model and receives generated text.

Server receives, as input, the prompt sentence constructed in Step 23. Server transmits the prompt sentence via a communication interface to the generative AI model, which may be located on an external service or on another processor. Server waits for the response and then receives generated natural language text in the form of a character or token sequence. Server verifies the response, optionally removes undesired tokens or truncates the text, and stores the generated text in memory. Server outputs natural language text information such as style proposals, reassurance messages, or sharing messages.

### Step 25:

Server prepares recommendation and explanation data for the terminal.

Server receives, as input, the ranked list of candidate items and the generated text information from Step 24. Server associates the generated style or explanation text with corresponding items and composes a response object containing item identifiers, thumbnails, prices, and the generated text. Server may also include additional metadata such as reasons for recommendation or emotion indicators. Server outputs the composed response and transmits it to the terminal.

### Step 26:

Terminal displays recommended items and generated explanations.

Terminal receives, as input, the response containing recommended items and natural language text. Terminal constructs user interface components such as lists or carousels for the recommended items and text areas or dialogs for the explanations. Terminal formats the generated text and binds it to appropriate on-screen elements. Terminal outputs the combined view so that the user can read suggestions and tap recommended items for further virtual fitting.

### Step 27:

User proceeds to purchase and terminal sends purchase instruction information.

Terminal receives, as input, user actions selecting one or more items to buy and confirming a purchase on a checkout screen. Terminal gathers cart contents, shipping address, and payment method data entered by the user. Terminal forms a purchase request, including these data and user identifiers, and encrypts the request. Terminal outputs purchase instruction information and sends it to the server.

### Step 28:

Server optionally generates reassurance text based on emotion thresholds.

Server receives, as input, the purchase instruction information and the integrated emotion state information for the items in the cart. If anxiety or indecision levels exceed predetermined thresholds, server constructs a prompt sentence instructing the generative AI model to generate a reassurance explanation for the purchase. Server transmits this prompt sentence, receives resulting text, and prepares an additional message about return conditions, size exchange, and styling versatility. Server outputs reassurance natural language text information and sends it to the terminal alongside or before executing payment processing.

### Step 29:

Terminal presents reassurance information and user confirms the final purchase.

Terminal receives, as input, the reassurance text from the server. Terminal displays the reassurance message near the purchase confirmation button. User reads the message and, if satisfied, performs a final confirmation action. Terminal captures this action and, if not already done, transmits a final purchase confirmation signal to the server. Terminal outputs a final purchase confirmation event.

### Step 30:

Server executes purchase processing and returns order details.

Server receives, as input, the final purchase confirmation and previously acquired settlement-related information. Server generates settlement processing information and communicates with a payment service via an application programming interface, transmitting and receiving transaction data. Server updates inventory records by generating inventory update information and applying stock decrements in the database. Server creates order records by generating order registration information and writing it to an order table. Server outputs purchase result data including order identifiers and status and sends this data to the terminal.

### Step 31:

User optionally shares a result and terminal sends a share request.

Terminal receives, as input, a user action selecting a “share” option for a particular item or outfit. Terminal collects the relevant item identifier and context (for example, the virtual fitting image or purchase confirmation). Terminal forms a share request containing the item identifier and user identifier, and transmits it to the server. Terminal outputs a share request message.

### Step 32:

Server generates a sharing short message based on joy level.

Server receives, as input, the share request along with the integrated emotion state information for the target item. If the joy level is above a threshold, server constructs a prompt sentence instructing the generative AI model to generate a short, friendly message suitable for an external information sharing service. Server sends the prompt sentence to the generative AI model, receives generated short text, and optionally verifies its length and content. Server outputs the generated short message and transmits it to the terminal.

### Step 33:

Terminal presents the sharing message as posting candidate information.

Terminal receives, as input, the short sharing message from the server. Terminal opens or prepares an interface for an external information sharing service and pre-fills a text field with the received short message. User can edit or approve the message. Terminal outputs the prepared posting content as candidate information for actual posting by the user.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

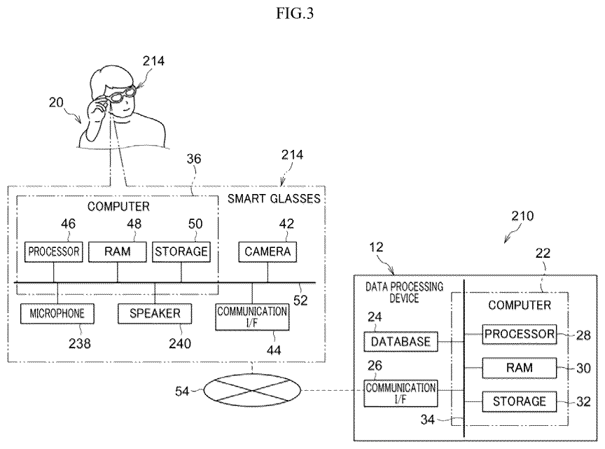

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

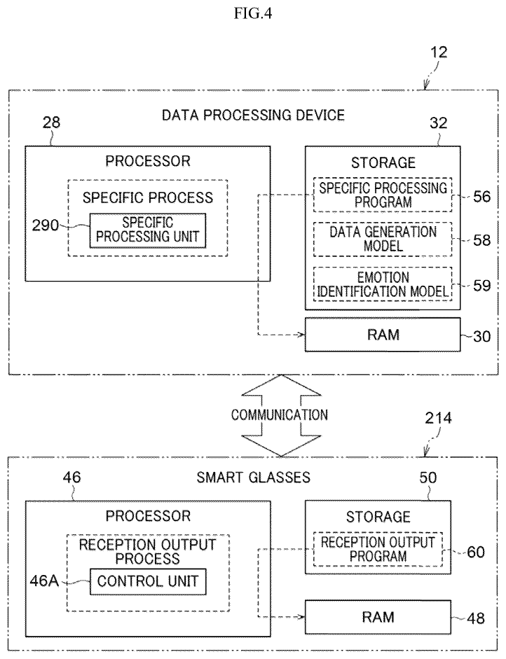

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

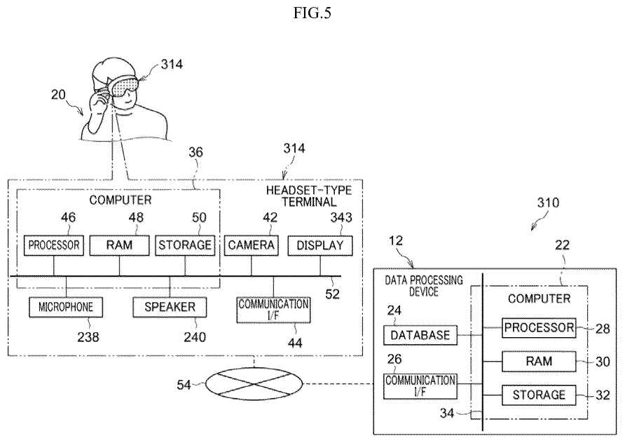

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

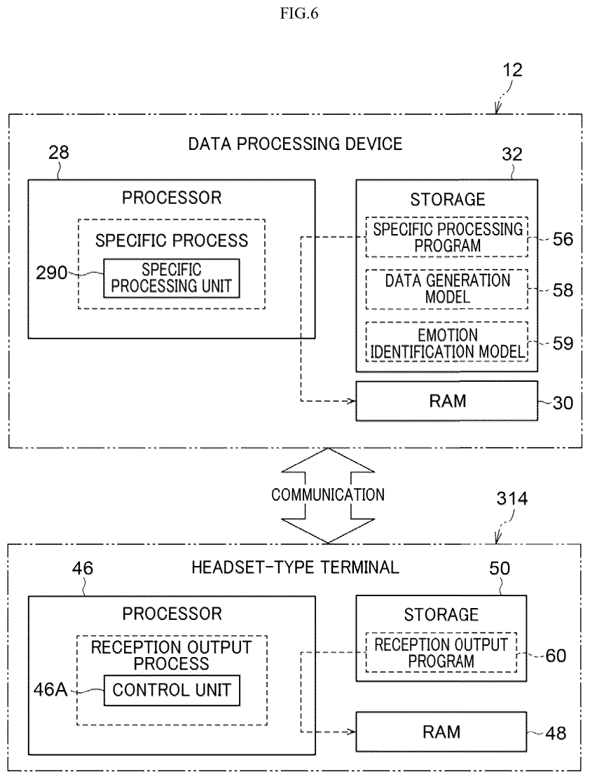

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

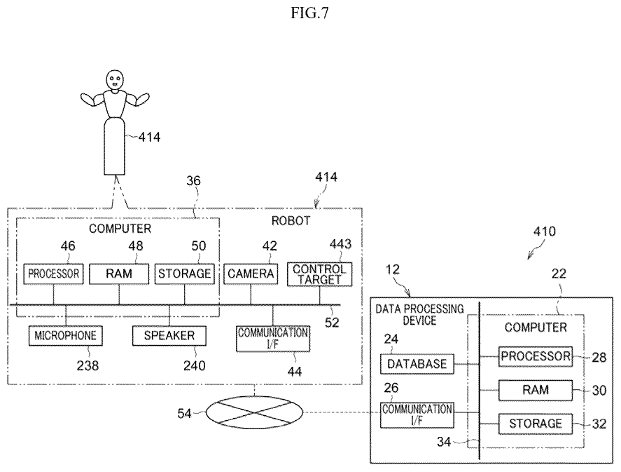

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

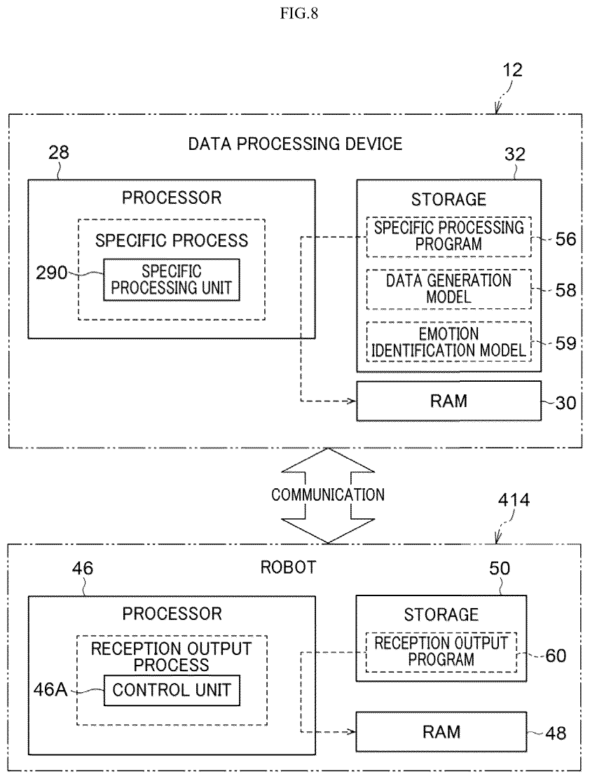

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

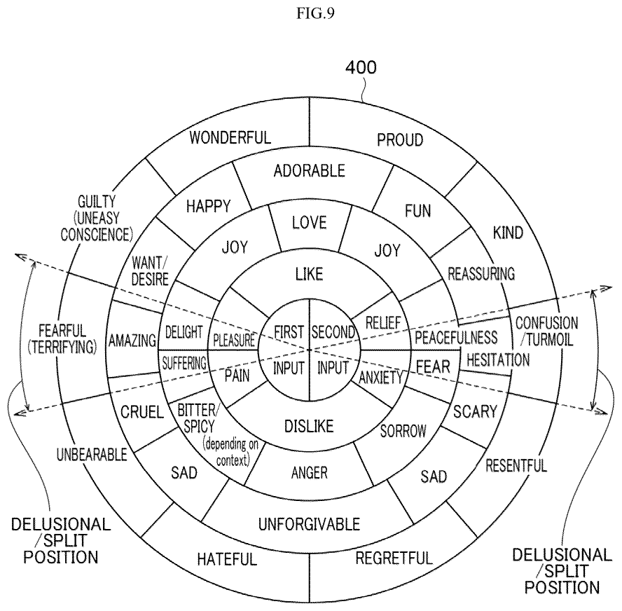

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

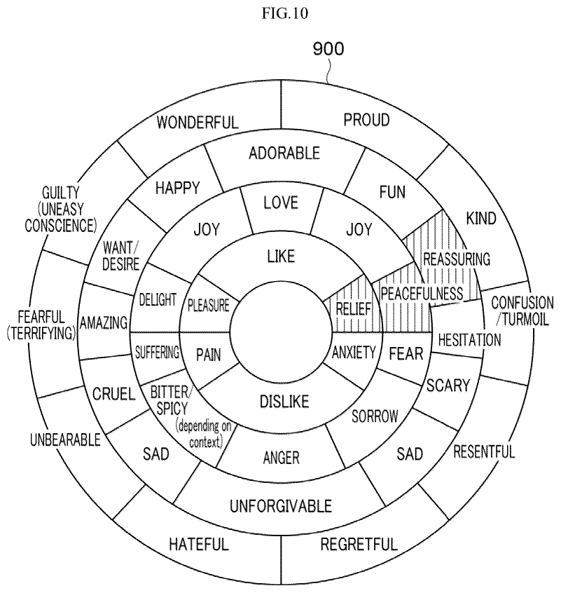

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire a body-part image of a user and store the body-part image as electronic information, accept a natural language input regarding an appearance style desired by the user and store the natural language input as electronic information,
analyze the body-part image to extract shape feature data including contour information and feature point information,
analyze the natural language input to extract style feature data including at least length information, shape information, color information, and fringe information,
normalize the style feature data into structured attribute information by transmitting inquiry data including a prompt sentence to a generative AI model and acquiring, as a response from the generative AI model, the structured attribute information,
generate a three-dimensional shape model of an appearance style suitable for the user based on the shape feature data and the structured attribute information,
set virtual illumination and viewpoint positions for the three-dimensional shape model and generate two-dimensional images from a plurality of directions,
superimpose at least one of the three-dimensional shape model and the two-dimensional images on the body-part image and generate a display screen for presentation to the user, generate, on the display screen, a plurality of appearance-style candidates by using the structured attribute information as parameters and by changing at least one of the length information, the color information, the volume information, and the fringe information of the appearance style, and present the plurality of appearance-style candidates to the user, transmit, to a treatment-terminal device, a three-dimensional shape model corresponding to an appearance-style candidate selected by the user, at least one two-dimensional image based on the three-dimensional shape model, and the structured attribute information, and provide the transmitted data as shared information, and
record the selected appearance-style candidate and evaluation information acquired from at least one of the treatment-terminal device and the user as history information, and perform learning control to update at least one of analysis processing of the style feature data and presentation processing of the appearance-style candidates based on the history information.

### (Supplementary 2)

The system according to supplementary 1,
wherein the processor is configured to
acquire the body-part image at high resolution and generate detailed feature data including contour information, eye-position information, nose-position information, mouth-position information, and jaw-position information, and
classify a face-shape type based on the detailed feature data and generate basic data used for suitability evaluation of the appearance style.

### (Supplementary 3)

The system according to supplementary 1,
wherein the processor is configured to
extract style feature data by extracting phrases from character information or a speech-recognition result input by the user, identifying characteristics of the desired appearance style based on context information, and transmitting a prompt sentence to the generative AI model to obtain the structured attribute information including the characteristics, and generate the three-dimensional shape model by individually customizing the appearance style based on the shape feature data and the structured attribute information, setting drawing parameters including texture information and volume information, and performing shading processing and texturing processing.

### Application Example 1

### (Supplementary 1)

A system comprising a processor,
wherein the processor is configured to
acquire, from a user device, image information including appearance information of a user, analyze the acquired image information to extract feature information including facial part information, contour information, and expression information,
normalize the extracted feature information and generate generation input data based on the normalized feature information,
generate, based on the generation input data and usage situation information related to the user, a natural language prompt sentence describing generation instructions for generating a three-dimensional body model corresponding to the user and a decoration target model applicable to the three-dimensional body model,
input the prompt sentence and the generation input data into a generative AI model, and receive, from the generative AI model, model data including the three-dimensional body model and the decoration target model,
store the model data in a storage device and manage parameters of the three-dimensional body model including body shape information, build information, and external appearance attribute information,
obtain digital shape data representing clothing item information and accessory information, and calculate an attachment state of the clothing item information and the accessory information with respect to the three-dimensional body model based on the parameters of the three-dimensional body model,
simulate, based on the calculated attachment state, deformation behavior of the clothing item information and the accessory information by a physical computation process to generate a virtual try-on state of the clothing item information and the accessory information on the three-dimensional body model,
render the virtual try-on state from a plurality of viewpoints and generate display image data, analyze selection history information, purchase history information, evaluation information, and information related to the virtual try-on state, and calculate, based on a result of the analysis, a plurality of combinations of clothing item information and accessory information suitable for the user,
generate, for at least one of the plurality of combinations, a recommendation prompt sentence for input to the generative AI model so as to cause the generative AI model to automatically generate a corresponding virtual try-on state,
and transmit, for a virtual try-on state selected by the user, product information corresponding to the virtual try-on state to a transaction processing apparatus and generate transaction information and sharing information for sharing the virtual try-on state with an external user.

### (Supplementary 2)

The system according to supplementary 1,
wherein the processor is configured to
acquire the image information including the appearance information of the user with a resolution equal to or higher than a predetermined resolution, thereby providing detailed data including the facial part information and the contour information,
extract, from the detailed data, face shape classification information and expression feature information as numerical feature values to be included in the generation input data, and generate, by using skeleton information and body surface information associated with the three-dimensional body model, a plurality of virtual try-on states including different visual appearances corresponding to different illumination condition information by temporally updating the deformation behavior of the clothing item information and the accessory information in the physical computation process.

### (Supplementary 3)

The system according to supplementary 1,
wherein the processor is configured to
compose the prompt sentence based on the feature information, the usage situation information, and preference information related to the user, the prompt sentence including generation instructions, constraint conditions, and expression conditions for causing the generative AI model to generate or update, in an integrated manner, the three-dimensional body model, the clothing item information, and the accessory information,
update recommendation policy information and a template of the recommendation prompt sentence by using, as learning data, the usage situation information and reaction information to the virtual try-on state generated by the physical computation process,
and dynamically change input content to the generative AI model by using the updated template of the recommendation prompt sentence and continuously generate, for each user, a plurality of personalized virtual try-on states.

### Example 2

### (Supplementary 1)

A system comprising a processor,
wherein the processor is configured to
acquire an image including a head of a user,
acquire a natural language input regarding a desired hairstyle of the user,
analyze the acquired image to detect a face region and to calculate feature values of a face shape and a hair region of the user,
analyze the acquired natural language input by performing morphological analysis and semantic analysis, and generate a hairstyle profile including a plurality of attributes comprising length, shape, presence or absence of bangs, color, impression tendency, and degree of image change,
estimate, on a basis of at least one of an expression image of the user, the natural language input, and an operation history of the user, an emotion state of the user including at least anxiety, satisfaction, excitement, confusion, and indifference,
generate a prompt sentence to be input to a generative artificial intelligence model, on a basis of the face shape and the feature values of the hair region, the hairstyle profile, and the emotion state, and cause the generative artificial intelligence model to generate a plurality of three-dimensional hairstyle models adapted to a head shape of the user by inputting the prompt sentence and face information of the user to the generative artificial intelligence model,
convert each of the plurality of three-dimensional hairstyle models into a standardized three-dimensional data format, and superimpose each of the plurality of three-dimensional hairstyle models on a face image or a three-dimensional head model of the user for display to the user, calculate, for each of the plurality of three-dimensional hairstyle models, an evaluation value on a basis of at least one of a degree of suitability to the face shape of the user, a degree of change from a current hairstyle of the user, and a degree of suitability to the emotion state, and present the plurality of three-dimensional hairstyle models to the user in an order according to the evaluation value, and
transmit information regarding a three-dimensional hairstyle model selected by the user and comment information based on the emotion state to an information processing terminal used by a beauty treatment provider, and enable the beauty treatment provider to browse the information.

### (Supplementary 2)

The system according to supplementary 1,
wherein the processor is configured to
acquire the image including the face of the user with a resolution sufficient to provide detailed pixel data for specifying positions of a contour of the face, eyes, a nose, a mouth, and a jaw of the user,
classify the face shape of the user into one of a plurality of categories on a basis of the contour of the face and positions of feature points,
classify, on a pixel basis, the hair region and a skin region in the image, determine a hair color category and a skin color category on a basis of the classified regions, and use the face shape category, the hair color category, and the skin color category as conditions for evaluating suitability of the hairstyle and for generating the three-dimensional hairstyle models.

### (Supplementary 3)

The system according to supplementary 1,
wherein the processor is configured to
extract, from a natural language text input by the user or a text obtained by speech recognition, keywords and impression expressions related to the hairstyle, identify, by contextual analysis, concrete features of the desired hairstyle and a tendency regarding a degree of image change of the user,
and generate, in accordance with the face shape and the feature values of the hair region, the hairstyle profile, and the emotion state, the prompt sentence including an instruction to suppress a degree of change or an instruction to emphasize the degree of change, and cause the generative artificial intelligence model to generate the plurality of three-dimensional hairstyle models having realistic texture and volume.

### Application Example 2

### (Supplementary 1)

A system comprising a processor,
wherein the processor is configured to
acquire, from an information processing terminal, image information including a face region of a user, and acquire body attribute information relating to the user,
extract facial feature information from the image information including the face region of the user, generate model information representing a virtual object corresponding to the user based on the facial feature information and the body attribute information, and store the model information in a storage device,
associate three-dimensional shape information corresponding to an apparel article or an accessory with the model information, synthesize the three-dimensional shape information and the model information, and generate display information for virtual fitting by the user, control the information processing terminal to display the display information for virtual fitting, and, during a period in which the display information for virtual fitting is displayed on the information processing terminal, acquire, from the information processing terminal, image information including an expression of the user and operation history information relating to an operation on the information processing terminal by the user,
execute image recognition processing based on the image information including the expression of the user and execute behavior analysis processing based on the operation history information, calculate emotion state information of the user, and generate integrated emotion state information by integrating a result of the image recognition processing and a result of the behavior analysis processing,
select candidate information of the apparel article or the accessory to be presented to the user based on selection history information and purchase history information relating to the user, the integrated emotion state information, and product attribute information relating to the apparel article or the accessory, and calculate priority information for the candidate information,
construct, in a natural language format, a prompt sentence to be input to a generative artificial intelligence model based on the integrated emotion state information, the selection history information, the purchase history information, and the product attribute information relating to the candidate information, transmit the prompt sentence to the generative artificial intelligence model via a communication interface, acquire natural language text information output from the generative artificial intelligence model in response to the prompt sentence, and output the natural language text information to the information processing terminal, and generate settlement processing information, inventory update information, and order registration information in response to purchase instruction information acquired from the information processing terminal, and perform purchase processing based on the settlement processing information, the inventory update information, and the order registration information.

### (Supplementary 2)

The system according to supplementary 1,
wherein the processor is configured to
apply a trained image recognition model to the image information including the expression of the user to calculate facial-expression-based emotion score information including probability values for a plurality of emotion types, extract, from the operation history information, feature information including screen stay time information, re-view count information, immediate-leave rate information, and purchase-behavior presence information, input the feature information to a behavior analysis model to calculate behavior-based emotion index information, and generate the integrated emotion state information by integrating the facial-expression-based emotion score information and the behavior-based emotion index information by weighted calculation or rule-based calculation.

### (Supplementary 3)

The system according to supplementary 1,
wherein the processor is configured to
in a case where anxiety level information or indecision level information included in the integrated emotion state information is equal to or greater than a predetermined threshold, construct a prompt sentence including content that instructs generation of an explanation sentence emphasizing return-condition information, size-exchange-condition information, and styling-versatility information, transmit the prompt sentence to the generative artificial intelligence model, acquire natural language text information output from the generative artificial intelligence model, and output the natural language text information as supplementary explanation information on a purchase screen of the information processing terminal, and, in a case where joy level information included in the integrated emotion state information is equal to or greater than a predetermined threshold, construct a prompt sentence including content that instructs generation of a sharing short message, transmit the prompt sentence to the generative artificial intelligence model, acquire short text information output from the generative artificial intelligence model, and output the short text information as posting candidate information for an external information sharing service to the information processing terminal.

What is claimed is:

1. A system comprising:
circuitry configured to:
receive, via a communication interface coupled to a packet-switched network, image data of a user from a terminal device and natural language input data representing a desired appearance attribute;
analyze the image data to extract feature data of the user;
analyze the natural language input data to extract style attribute data;
generate a three-dimensional model based on the feature data and the style attribute data;
superimpose the three-dimensional model on the image data and transmit a composite display data structure to the terminal device via the communication interface;
present a plurality of candidate three-dimensional models to the user via the terminal device; and
transmit data representing a selected candidate three-dimensional model to a second terminal device via the communication interface.

2. The system according to claim 1, wherein the circuitry analyzes the image data using a convolutional neural network to extract the feature data including contour information representing a boundary shape of a body part of the user and feature point coordinates representing positions of anatomical landmarks.

3. The system according to claim 2, wherein the circuitry classifies a shape category of the body part based on the contour information and the feature point coordinates, and associates the shape category with compatibility scores for a plurality of style attribute combinations stored in a storage device coupled to the packet-switched network.

4. The system according to claim 3, wherein the circuitry further extracts color distribution data and texture pattern data from the image data, and incorporates the color distribution data and the texture pattern data into the feature data for use in generating the three-dimensional model.

5. The system according to claim 1, wherein the circuitry analyzes the natural language input data by extracting keywords and determining contextual intent using a natural language processing model to identify style attributes including at least one of length information, shape information, color information, and fringe configuration information.

6. The system according to claim 5, wherein the circuitry constructs a prompt data structure encoding the extracted style attributes, transmits the prompt data structure to a generative neural network model comprising a transformer architecture with a plurality of self-attention layers, and receives from the generative neural network model structured attribute information normalizing the extracted style attributes into parameterized values.

7. The system according to claim 6, wherein the circuitry further transmits to the generative neural network model an updated prompt data structure encoding the feature data together with the structured attribute information, and receives from the generative neural network model texture image data for application to surfaces of the three-dimensional model.

8. The system according to claim 1, wherein the circuitry generates the three-dimensional model by constructing polygon mesh geometry conforming to the feature data, and applies shading and texturing to the polygon mesh geometry to represent volume and surface characteristics.

9. The system according to claim 8, wherein the circuitry renders the three-dimensional model by setting virtual illumination positions and a plurality of viewpoint positions, and generates two-dimensional rendered images from the plurality of viewpoint positions for inclusion in the composite display data structure.

10. The system according to claim 9, wherein the circuitry superimposes the three-dimensional model on the image data by performing geometric alignment between the feature point coordinates extracted from the image data and corresponding anchor points on the three-dimensional model, and applies alpha blending at boundary regions to produce a visually seamless composite.

11. The system according to claim 1, wherein the circuitry generates the plurality of candidate three-dimensional models by programmatically varying at least one parameter of the style attribute data including at least one of length, color, volume, and fringe configuration, and renders each candidate three-dimensional model superimposed on the image data.

12. The system according to claim 11, wherein the circuitry ranks the plurality of candidate three-dimensional models based on compatibility scores computed from the feature data and the varied style attribute parameters, and presents the candidate three-dimensional models to the user in an order determined by the ranking.

13. The system according to claim 1, wherein the data transmitted to the second terminal device includes the selected candidate three-dimensional model, two-dimensional rendered images of the selected candidate from a plurality of viewpoint positions, and structured attribute information specifying parameterized style values of the selected candidate.

14. The system according to claim 13, wherein the circuitry receives, from the second terminal device via the communication interface, modification request data indicating adjustments to at least one parameter of the structured attribute information, regenerates the three-dimensional model based on the adjusted parameter, and transmits the regenerated model to both the terminal device and the second terminal device.

15. The system according to claim 1, wherein the circuitry is further configured to:
record history data including the selected candidate three-dimensional model and evaluation data received from at least one of the terminal device and the second terminal device; and
update at least one of the analysis of the natural language input data and the generation of candidate three-dimensional models based on the history data.

16. The system according to claim 15, wherein the circuitry estimates an emotional state of the user based on at least one of facial expression features extracted from the image data, text sentiment extracted from the natural language input data, and interaction timing patterns received from the terminal device.

17. The system according to claim 16, wherein the circuitry adjusts a degree of variation among the plurality of candidate three-dimensional models based on the estimated emotional state, generating candidates with smaller parameter variations when the estimated emotional state indicates a low tolerance for change and generating candidates with larger parameter variations when the estimated emotional state indicates a high tolerance for change.

18. A system comprising:
a communication interface including a network interface controller coupled to a packet-switched network and configured to transmit and receive data packets;
a memory storing instructions, a convolutional neural network model for feature extraction, a natural language processing model, and a generative neural network model; and
circuitry comprising one or more processors coupled to the memory and configured to execute the instructions to:
receive, via the communication interface, image data of a user from a terminal device and natural language input data representing a desired appearance attribute;
extract feature data from the image data using the convolutional neural network model, the feature data including contour information and feature point coordinates;
extract style attribute data from the natural language input data using the natural language processing model, and transmit a prompt data structure encoding the style attribute data to the generative neural network model to receive structured attribute information;
generate a three-dimensional model based on the feature data and the structured attribute information by constructing polygon mesh geometry and applying shading and texturing;
superimpose the three-dimensional model on the image data and transmit a composite display data structure to the terminal device via the communication interface;
generate a plurality of candidate three-dimensional models by varying at least one parameter of the structured attribute information and transmit the candidates to the terminal device; and
transmit data representing a selected candidate three-dimensional model and the corresponding structured attribute information to a second terminal device via the communication interface.

19. The system according to claim 18, wherein the circuitry is further configured to estimate an emotional state of the user based on at least one of facial expression features extracted from the image data and text sentiment extracted from the natural language input data, and to adjust a degree of variation among the plurality of candidate three-dimensional models based on the estimated emotional state.

20. A method performed by circuitry of a server coupled to a packet-switched network via a communication interface, the method comprising:
receiving, via the communication interface, image data of a user from a terminal device and natural language input data representing a desired appearance attribute;
analyzing the image data to extract feature data of the user;
analyzing the natural language input data to extract style attribute data;
generating a three-dimensional model based on the feature data and the style attribute data;
superimposing the three-dimensional model on the image data and transmitting a composite display data structure to the terminal device via the communication interface;
presenting a plurality of candidate three-dimensional models to the user via the terminal device; and
transmitting data representing a selected candidate three-dimensional model to a second terminal device via the communication interface.
